(19) United States
(12) Patent Application Publication
(10) Pub. No.: US 2005/0238914 A1
(43) Pub. Date: Oct. 27, 2005

(54) Polysilsesquioxane-based compound and organic electroluminescence device using the same

(76) Inventors: Yi-Yeol Lyu, Daejeon-si (KR); Lyong-Sun Pu, Suwon-si (KR); Seok Chang, Daejeon-si (KR); Tae-Yong Noh, Gunpo-si (KR); Jhun-Mo Son, Yongin-si (KR); Hae-Jung Son, Seoul (KR); Ouck Han, Daejeon-si (KR); Eun-Sil Han, Daejeon-si (KR); Jin-Heong Yim, Suwon-si (KR)

Correspondence Address: Robert E. Bushnell, Suite 300, 1522 K Street, N.W., Washington, DC, 20005, US

(21) Appl. No.: 11/028,221

(22) Filed: Jan. 4, 2005

(30) Foreign Application Priority Data
Jan. 27, 2004 (KR) 2004-4985

(51) Int. Cl. H05B 33/14; C09K 11/06; C08G 77/00; C07F 7/02

(52) U.S. Cl. 428/690; 428/917; 428/448; 313/504; 313/506; 556/400; 556/466; 556/9

(57) ABSTRACT

A polysilsesquinone-based compound with an organometallic complex, which is bonded to a side chain of polysilsesquinoxane, enabling highly efficient phospholuminescence and an organic electroluminescent device using the same. The organometallic complex, which is suitably used for forming an organic layer of the organic electroluminescent device, provides a luminescence maximum emission in the wavelength range of 400-650 nm, and induces white electroluminescence when combined with green or red luminescent materials.

### CLAIM OF PRIORITY

This application claims the priority of Korean Patent Application No. 2004-4985, filed Jan. 27, 2004, in the Korean Intellectual Property Office, the disclosure of which is incorporated herein in its entirety by reference.

### BACKGROUND OF THE INVENTION

1. Field of the Invention

The present invention relates to a polysilsesquioxane-based luminescent material and to an organic electroluminescence (EL) device using the same, and more particularly, to a polysilsesquioxane-based luminescent material capable of emitting light over a wide range from a blue region to a red region through triplet metal-to-ligand charge transfer (MLCT) and an organic electroluminescence device using the same as an organic layer forming material.

2. Description of the Related Art

A general organic EL device includes an anode, a hole injection layer, a hole transport layer, a light-emitting layer, an electron transport layer, an electron injection layer, and a cathode sequentially formed on a substrate. The hole transport layer, the light-emitting layer, and the electron transport layer are organic layers made of organic compounds. The organic EL device having the above-described configuration is driven as follows. When a voltage is applied between the anode and the cathode, holes injected from the anode migrate to the light-emitting layer via the hole transport layer. Electrons emitted from the cathode are injected into the light-emitting layer via the electron transport layer. The electrons and the holes recombine in the light-emitting layer to generate excitons. While the excitons radioactively decay, light corresponding to a band gap of the molecules is emitted.

Materials for forming the light-emitting layer of the organic EL device are classified into a fluorescent material which uses a singlet and a phosphorescent material which uses a triplet, according to a light-emitting mechanism. The fluorescent material or the phosphorescent material forms a light-emitting layer itself or by being doped to an appropriate host material. As a result of electron excitation, singlet excitons and triplet excitons are produced in the host. Statistically, the singlet excitons and the triplet excitons in an OLED (organic light emitting diode (or device)) are created in a ratio of about 1:3. Conventional organic EL devices using a fluorescent material as a material for forming a light-emitting layer are disadvantageous in that triplets are consumed from the host. However, conventional organic EL devices using a phosphorescent material as a material for forming a light-emitting layer are advantageous in that singlet excitons and triplet excitons are both utilized to achieve the internal quantum efficiency of 100%. Thus, an organic EL device using a phosphorescent material as a material for forming a light-emitting layer has a high emission efficiency compared with an organic EL device using a fluorescent material.

Introduction of a heavy metal such as Ir, Pt, Rh, or Pd to organic molecules has led to spin-orbital coupling due to a heavy atom effect so that a triplet state and a singlet state coexist, allowing phospholuminescence to occur even at room temperature.

More recently, development has led to the discovery of highly efficient green and red luminescent materials using photoelectroluminescence of up to 100%. In particular, a green phospholuminescent (PL) material using fac tris(2-phenylpyridine)iridium (Ir(ppy)₃) has an external quantum efficiency of 17.6±0.5%. Bis(2-(2′-benzo[4,5-a]thienyl)pyridinato-N,C) iridium (acetylacetonate) (Btp2Ir(acac)) has been reported as a red EL material having a high emission efficiency of 7.0±0.5%. As described above, as highly efficient luminescent materials using phospholuminescence, various materials employing various transition metal complexes containing a transition metal such as iridium or platinum, have been being reported. However, materials satisfying requirements for realizing a full-color display of high emission efficiency or white electroluminescence with low power consumption are only restricted to ones emitting in the green and red ranges, and blue phosphorescent materials have not been reported, making it difficult to achieve a full-color display, which is, in turn, becoming a barrier to development of phospholuminescent full-color display devices.

To address the above-described problems, intensive development of blue luminescent materials is under way. Also, there have been proposed organometallic complexes having a bulky functional group or a functional group having a high intensity ligand field, e.g., a cyano group, introduced thereto to increase a difference between HOMO (Highest Occupied Molecular Orbital: HOMO)-LUMO (Lowest Unoccupied Molecular Orbital: LUMO) energy levels by transforming the molecular geometry. The above-stated materials are typically subjected to chemical vapor deposition to manufacture organic electroluminescence devices. Alternatively, there have been proposed compounds used in manufacturing organic electroluminescence device by spin coating. Those compounds include organometallic complexes bonded to side chains of hydrocarbon polymers such as styrene-based polymers and acryl-based polymers, as disclosed in Japanese Laid-Open Publication No. 2003-77675 A, JP Japanese Laid-Open Publication No. 2003-73666 A, Japanese Laid-Open Publication No. 2003-77675 A, Japanese Laid-Open Publication No. 2003-119179 A, Japanese Laid-Open Publication No. 2003-113246 A, Japanese Laid-Open Publication No. 2003-147021 A, Japanese Laid-Open Publication No. 2003-171391 A, Japanese Laid-Open Publication No. 2003-73480 A, Japanese Laid-Open Publication No. 2003-73479 A, and so on, or dendrimers, as described in WO 99/21935 and WO 02/066552 A1. Despite extensive research, development of high-efficiency phospholuminescent materials is still much required.

### SUMMARY OF THE INVENTION

It is therefore an object of the present invention to provide an improved luminescent material and an improved organic electroluminescent device.

It is further an object of the present invention to provide a polysilsesquioxane-based compound capable of emitting light over a wide range from a blue region to a red region through triplet metal-to-ligand charge transfer (MLCT).

It is another object of the present invention to provide an organic electroluminescence device using the polysilsesquioxane-based compound as an organic layer forming material.

In order to achieve above and other objects, the present invention may be constructed with a polysilsesquioxane-based compound.

In an aspect of the present invention, there is provided a polysilsesquinone-based compound having a unit represented by Formula 1a:
—(R₁₁SiO_{1.5})ₙ— (1a)
wherein R₁₁ represents an organometallic complex containing group having a metal selected from the group consisting of Ir, Os, Pt, Pb, Re, Ru and Pd;
n is an integer not less than 2.

In another aspect of the present invention, there is provided a polysilsesquinone-based compound with an organometallic complex bonded to a side chain of polysilsesquioxane, represented by Formula 1b:
—[—(R₁SiO_{1.5})ₐ—(R₁₁SiO_{1.5})_{b}—]ₙ— (1b)
wherein R₁ is independently selected from the group consisting of a hydrogen atom, a hydroxy group, a C1-C15 alkyl group, a C1-C15 alkoxy group, a C6-C20 aryl group, a C7-C25 alkylaryl group and a C7-C25 arylalkyl group;
R₁₁ represents an organometallic complex-containing group having a metal selected from the group consisting of Ir, Os, Pt, Pb, Re, Ru and Pd;
n is an integer not less than 2; and
a mixing molar ratio of a and b is 1:99 to 99:1.

In other feature of an embodiment of the present invention, there is provided an organic electroluminescent device comprising an organic layer between a pair of electrodes, wherein the organic layer comprises the polysilsesquioxane-based compound.

### DETAILED DESCRIPTION OF THE PREFERRED EMBODIMENTS

Reference will now be made in detail to the present preferred embodiments of the present invention.

The term “organometallic complex” used in the present invention refers to a metal complexed with at least one of a monoanionic ligand, a monodentate ligand, a bidentate ligand, and a carbon-coordination ligand. Here, at least one electron-donating or electron-withdrawing substituent is bonded to the ligand(s).

The present invention provides a polysilsesquinone-based compound with an organometallic complex bonded to a side chain of polysilsesquioxane, represented by Formula 1a:
—(R₁₁SiO_{1.5})ₙ— [Formula 1a]
wherein R₁₁ represents an organometallic complex-containing group having a metal selected from the group consisting of Ir, Os, Pt, Pb, Re, Ru and Pd; and
n is an integer greater than or equal to 2.

The present invention provides a polysilsesquinone-based compound with an organometallic complex bonded to a side chain of polysilsesquioxane, represented by Formula 1b:
—[—(R₁SiO_{1.5})ₐ—(R₁₁SiO_{1.5})_{b}—]ₙ— [Formula 1b]
wherein R₁ is independently selected from the group consisting of a hydrogen atom, a hydroxy group, a C1-C15 alkyl group, a C1-C15 alkoxy group, a C6-C20 aryl group, a C7-C25 alkylaryl group and a C7-C25 arylalkyl group;
R₁₁ represents an organometallic complex-containing group having a metal selected from the group consisting of Ir, Os, Pt, Pb, Re, Ru and Pd;
n is an integer not less than 2; and
a mixing molar ratio of a and b is 1:99 to 99:1.

In Formula 1a or 1b, n is preferably an integer of greater than or equal to 2, more preferably, from 10 to 3,000, and most preferably from 10 to 1,000,

An average molecular weight of the polysilsesquioxane-based compound represented by Formula 1a or 1b is preferably in a range of 1,000 to 500,000, more preferably in a range of 3,000 to 200,000.

The organometallic complex-containing group is represented by Formula 2 or 3: 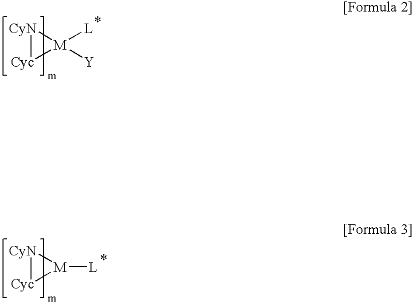
wherein M is Ir, Os, Pt, Pb, Re, Ru or Pd; and
CyN is a substituted or unsubstituted C3-C60 heterocyclic group containing nitrogen bonded to M, or a substituted or unsubstituted C3-C60 heteroaryl group containing nitrogen bonded to M;
CyC is a substituted or unsubstituted 4 to 60 carbocyclic group containing carbon bonded to M, substituted or unsubstituted C3-C60 heterocyclic group containing carbon bonded to M, a substituted or unsubstituted C3-C60 aryl group containing carbon bonded to M or a substituted or unsubstituted C3-C60 heteroaryl group containing carbon bonded to M;
CyN-CyC represents a cyclometalating ligand bonded to M through nitrogen (N) and carbon (C);
L is a monodentate or bidentate ligand;
Y is a monoanionic or monodentate ligand;
m is 1 or 2;
the asterisk (*) symbol indicates a bonding position for Si.

In Formulas 2 and 3, CyN-CyC ligands are represented by the following Formulas (a) through (p): 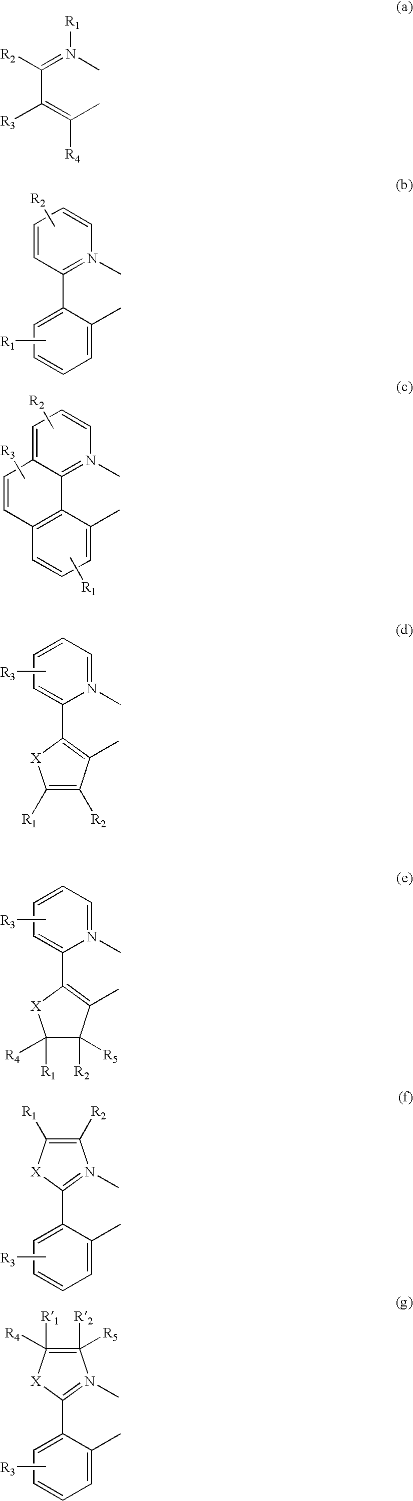 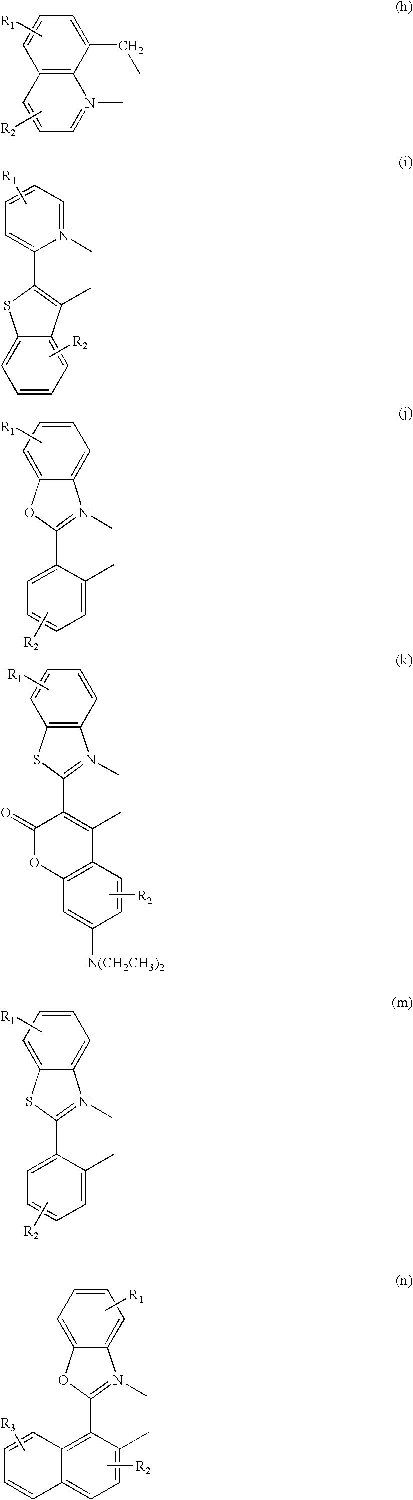 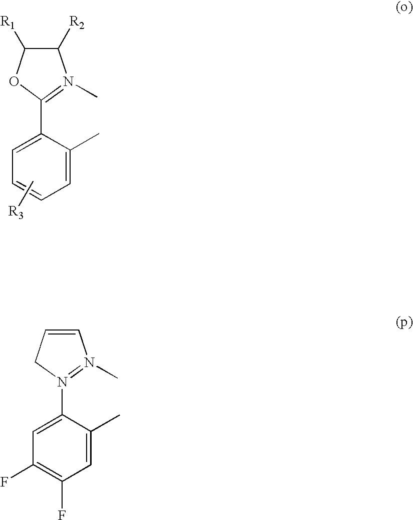
wherein L is one of ligands represented by the following Formulas (q) through (z), and (a′) through (p′), or derived from one selected from the group consisting of a substituted or unsubstitued triethylamine, a substituted or unsubstitued propylamine, a substituted or unsubstituted cyclohexylamine, a substituted or unsubstitued pyrrolidine, a substituted or unsubstitued pyrroline, a substituted or unsubstitued piperidine, a substituted or unsubstitued pyrimidine, a substituted or unsubstitued indole, a substituted or unsubstitued azaindole, a substituted or unsubstitued carbazole, a substituted or unsubstitued indazole, a substituted or unsubstitued norharman, a substituted or unsubstitued harman, a substituted or unsubstitued aniline, a substituted or unsubstitued imidazole, a substituted or unsubstitued oxazole, a substituted or unsubstitued thiazole, a substituted or unsubstitued pyrazole, a substituted or unsubstitued pyrrole, a substituted or unsubstitued benzimidazole, a substituted or unsubstitued benzotriazole, a substituted or unsubstitued benzoxazole, a substituted or unsubstitued benzothiazole, a substituted or unsubstitued benzoselenazole, a substituted or unsubstitued benzothiadiazole, a substituted or unsubstitued isoxazole, a substituted or unsubstitued isothiazole, a substituted or unsubstitued oxadiazole, a substituted or unsubstitued thiadiazole, a substituted or unsubstitued anthranyl, a substituted or unsubstitued triazine, a substituted or unsubstitued benzisoxazole, a substituted or unsubstitued pyrazine, a substituted or unsubstitued quinoline, a substituted or unsubstitued benzoquinoline, a substituted or unsubstitued acridine, a substituted or unsubstitued thiazoline, a substituted or unsubstitued quinuclidine, a substituted or unsubstitued imidazoline, a substituted or unsubstitued oxazoline, a substituted or unsubstitued thiazoline, and a substituted or unsubstitued isoquinoline; and
Y is —F, —Cl, —Br, —I, —CN, —CN(R′″), —SCN or —OCN, where R′″ is a substituted or unsubstituted C1-C20 alkyl group. 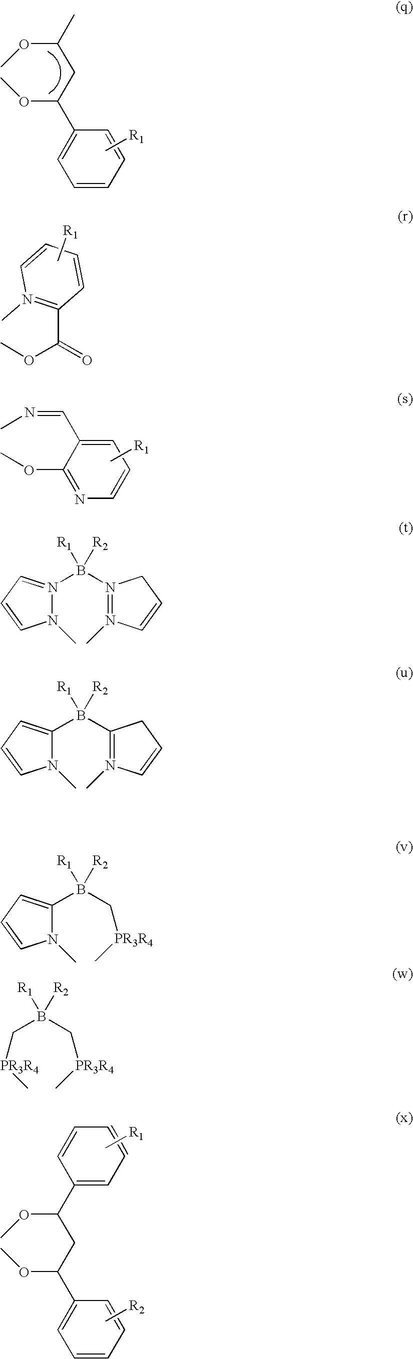 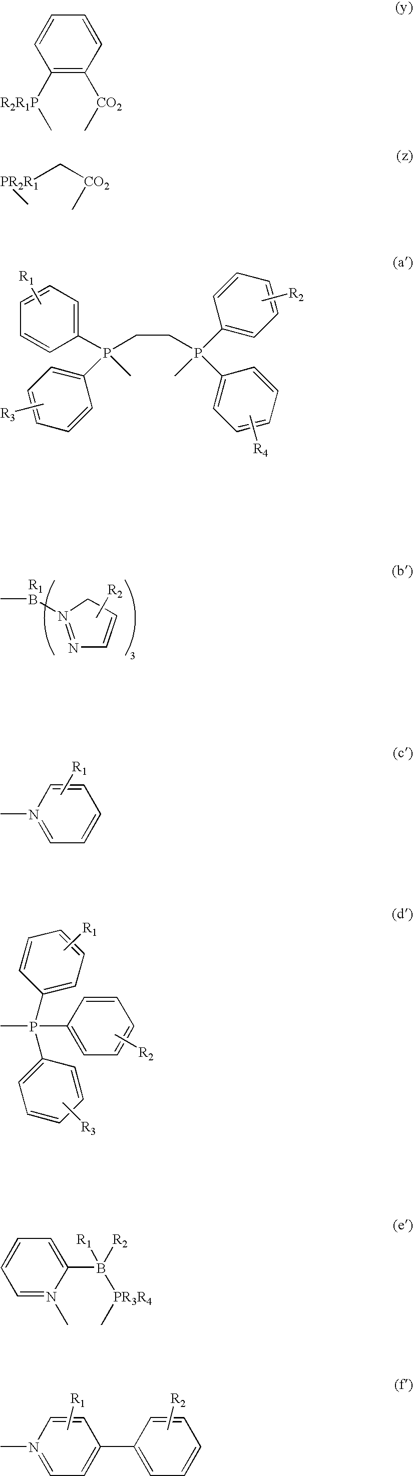 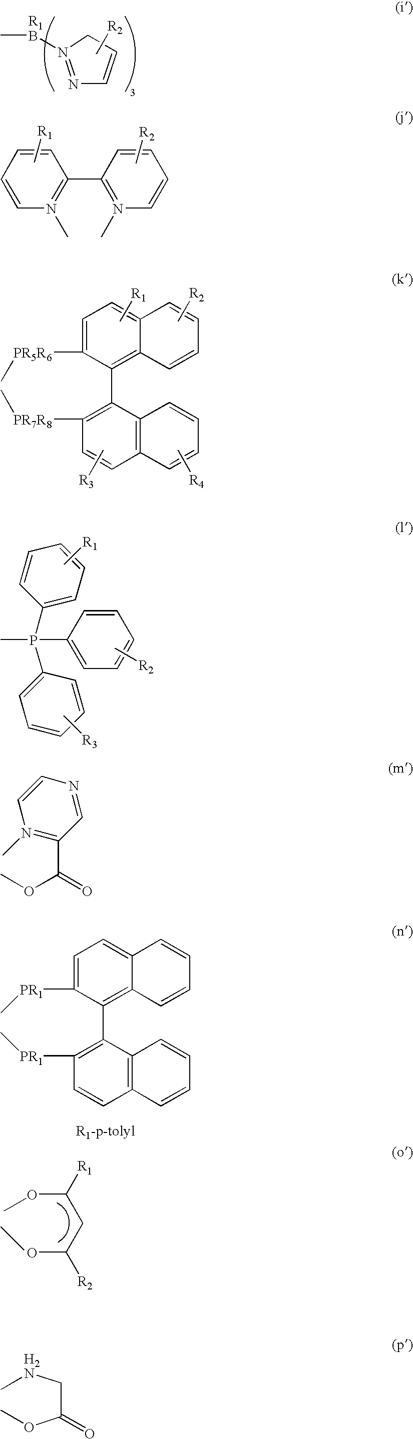
wherein R₁, R₂, R₃, R₄, R₅, R₆, R₇ and R₈ are each independently a monosubstituted or multisubstituted substituent, and are each selected from the group consisting of hydrogen, a halogen atom, —OR′, —N(R′)₂, —P(R′)₂, —POR′, —PO₂R′, —PO₃R′, —SR′, —Si(R′)₃, —B(R′)₂, —B(OR′)₂, —C(O)R′, —C(O)OR′, —C(O)N(R′), —CN, —NO₂, —SO₂, —SOR, —SO₂R′, —SO₃R′, C1-C20 alkyl, or C6-C20 aryl, where R′ is a hydrogen atom, substituted or unsubstituted C1-C20 alkyl, substituted or unsubstituted C1-C10 alkoxy, substituted or unsubstituted C2-C20 alkenyl, substituted or unsubstituted C2-C20 alkynyl, substituted or unsubstituted C1-C20 heteroalkyl, substituted or unsubstituted C6-C40 aryl, substituted or unsubstituted C7-C40 arylalkyl, substituted or unsubstituted C7-C40 alkylaryl, substituted or unsubstituted C2-C40 heteroaryl, and substituted or unsubstituted C3-C40 heteroarylalkyl;
X is CH, S, O or NR″, where R″ is a hydrogen atom or a C1-C20 alkyl group; and
E is O, S, Se or Te.

Preferably, L is a ligand derived from pyrazole, 2-pyridinemethanol, imidazole, or 4-hydroxyphenylacetylacetonate.

Specific examples of the ligand represented by Formula (b) include the ligands represented by Formulae (b-1), (b-2) and (b-3). Example of the ligand represented by Formula (f) includes the ligand represented by Formula (f-1). Examples of the ligand represented by Formula (q) include the ligands represented by Formulae (q-1) through (q-4).

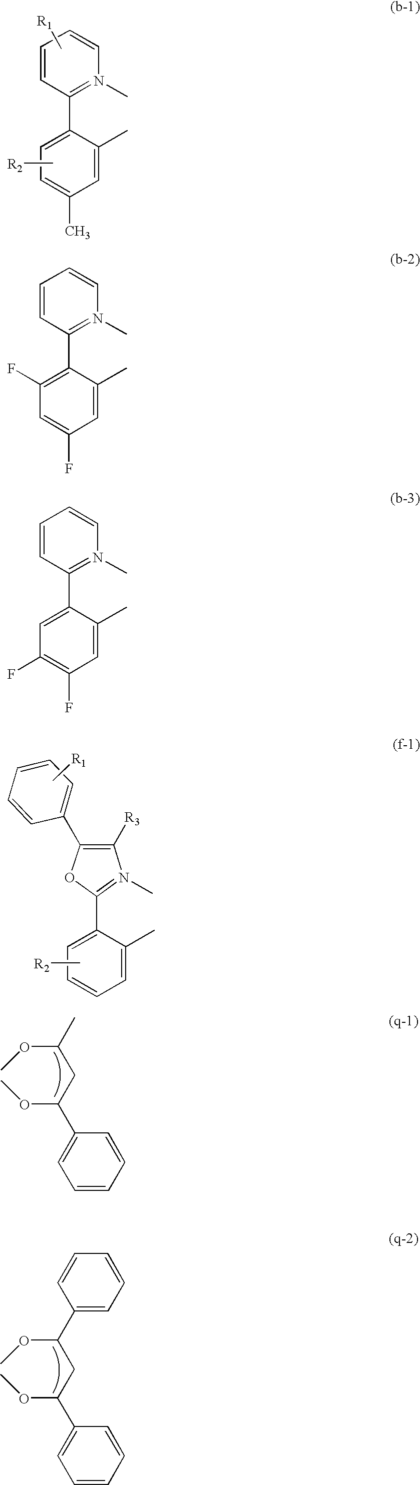

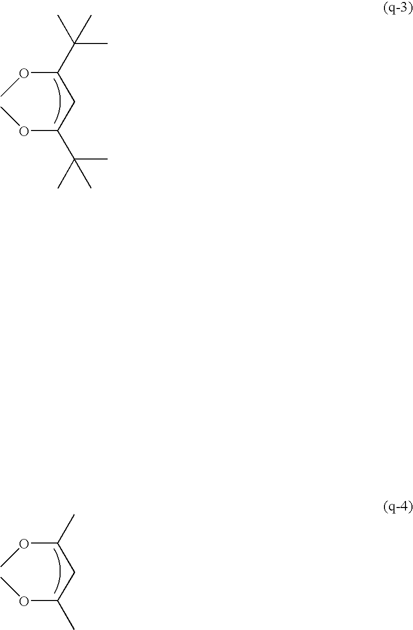

In Formulas 2 and 3, the heterocyclic group and the heteroaryl group are the cyclic group and the aryl groups containing at least one hetero atom, such as N, O, or S, respectively.

In CyN of Formulas 2 and 3, specific examples of the substituted or unsubstituted C3-C60 heterocyclic group containing carbon bonded to M include pyrrolidine, morpholine, thiomorpholine, thiazolidine and the like, and specific examples of the substituted or unsubstituted C3-C60 heteroaryl containing carbon bonded to M include pyridine, 4-methoxy pyridine, quinonoline, pyrorrole, indole, pyridine, pyrazine, pyrazole, imidazole, pyrimidine, quinazoline, thiazole, oxazole, triazine, 1,2,4-triazole and the like.

In CyC of Formulas 2 and 3, specific examples of the substituted or unsubstituted C4-C60 carbocyclic bonded to M include cyclohexane, cyclopentane and the like. Specific examples of the substituted or unsubstituted C3-C60 heterocyclic group include tetrahydrofuran, 1,3-dioxane, 1,3-dithiane, 1,3-dithiolane, 1,4-dioxa-8-azaspiro[4,5]decane, 1,4-dioxaspiro[4,5]decan-2-one and the like. Specific examples of the substituted or unsubstituted C4-C60 aryl group containing carbon bonded to M include phenyl, 1,3-benzodioxole, biphenyl, naphthalene, anthracene, azulene and the like. Specific examples of the substituted or unsubstituted C3-C60 heteroaryl group containing carbon bonded to M include thiophene, furan2(5H)-furanone, pyridine, coumarin, imidazole, 2-phenylpyridine, 2-benzothiazole, 2-benzooxazole, 1-phenylpyrazole, 1-naphthylpyrazole, 5-(4-methoxyphenyl)pyrazole, 2,5-bisphenyl-1,3,4-oxadiazole, 2,3-benzofuran2-(4-biphenyl)-6-phenyl benzooxazole and the like.

In Formulas 2 and 3, the respective substituents of CyN-CyC are interconnected to form a substituted or unsubstituted 4- to 7-membered cyclic ring or a substituted or unsubstituted 4- to 7-membered heterocyclic group, in particular, a fused 4- to 7-membered cyclic or heterocyclic group. Here, the cyclic group or hetero cyclic group represents a C1-C30 cycloalkyl, C1-C30 heterocycloalkyl, C6-C30 aryl or C4-C30 heteroallyl, each cyclic group or heterocyclic group can be substituted by one or more substituents. The term “hetero” used herein is intended to encompass a hetero atom such as N, O, P, or S.

The substituent represents a halogen atom, —O R₁′, —N(R₁′)₂, —P(R₁′)₂, —POR₁′, —PO₂R₁′, —PO₃R₁′, —SR₁′, —Si(R₁′)₃, —B(R₁′)₂, —B(OR₁′)₂, —C(O)R₁′, —C(O)OR₁′, —C(O)N(R₁′), —CN, —NO₂, —SO₂, —SOR₁′, —SO₂R₁′, or —SO₃R₁′, and R₁′ is as defined as in R′.

A method of preparing the polysilsesquioxane represented by Formula 1a or 1b according to the present invention will now be described.

The polysilsesquioxane represented by Formula 1a or 1b can be prepared by two methods.

First, a ligand (L) containing compound (L is a ligand represented by (q) through (z) and (a′) through (p′)) and chlorotrialkoxysilane ClSi(OR₃′)₃, where R₃′ is a hydrogen atom or a C1-C15 alkyl, are reacted to obtain a compound represented by Formula 11:
L-Si(OR₃′)₃ [Formula 11]
wherein R₃′ is a hydrogen atom or a C1-C15 alkyl group.

The compound represented by Formula 11 undergoes, singly or in combination with R₄′SiX₁X₂X₃ compound (where, X₁, X₂, and X₃ are each independently selected from the group consisting of a hydrogen, halogen atom, hydroxy, C1-C15 alkyl, C1-C15 alkoxy, C6-C20 aryl, C7-C25 alkylaryl and C7-C25 arylalkyl), hydrolysis, dehydration and polycondensation in the presence of an acid or base catalyst and water, to give a compound represented by Formula 12a or 12b:
—[R₄′SiO_{1.5}]ₙ—[Formula 12a]
-[-(LSiO_{1.5})ₐ—(R₄′SiO_{1.5})_{b}—]ₙ— [Formula 12b]
wherein R₄′ is selected from the group consisting of a hydrogen atom, a halogen atom, hydroxy, C1-C15 alkyl, C1-C15 alkoxy, C6-C20 aryl, C7-C25 alkylaryl and C7-C25 arylalkyl;
L is a ligand represented by (q) through (z) and (a′) through (p′);
n is a number greater than or equal to 2; and
a mixing molar ratio of a and b is 1:99 to 99:1.

The compound of Formula 12a or 12b is reacted with an organometallic complex represented by Formula 13 or 14 to obtain the compound represented by Formula 1a or 1b: 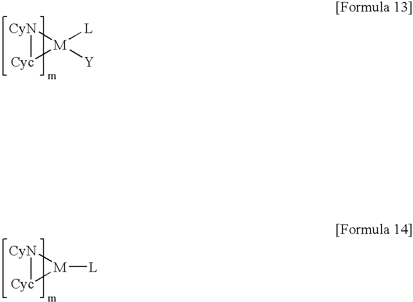
wherein M is Ir, Os, Pt, Pb, Re, Ru or Pd;
CyN is a substituted or unsubstituted C3-C60 heterocyclic group containing nitrogen bonded to M, or a substituted or unsubstituted C3-C60 heteroaryl group containing nitrogen bonded to M;
CyC is a substituted or unsubstituted 4 to 60 carbocyclic group containing carbon bonded to M, substituted or unsubstituted C3-C60 heterocyclic group containing carbon bonded to M, a substituted or unsubstituted C3-C60 aryl group containing carbon bonded to M or a substituted or unsubstituted C3-C60 heteroaryl group containing carbon bonded to M;
CyN-CyC represents a cyclometalating ligand bonded to M through nitrogen (N) and carbon (C);
L is a monodentate or bidentate ligand;
Y is a monoanionic or monodentate ligand; and
m is 1 or 2.

Another possible preparation method of the polysilsesquioxane represented by Formula 1a or 1b will now be described.

The organometallic complex represented by Formula 13 or 14 is reacted with chlorotrialkoxysilane ClSi(OR₃′)₃, wherein R₃′ is a hydrogen atom or a C1-C15 alkyl group, to obtain a compound represented by Formula 15 or 16: 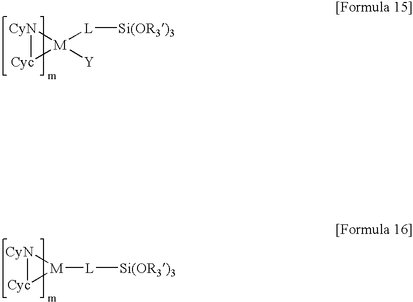
wherein R₃′ is a hydrogen atom or a C1-C15 alkyl group, and CyN, CyC, M, L, Y, and m are as defined as above.

The compound represented by Formula 15 or 16 undergoes, singly or in combination with R₄′SiX₁X₂X₃ compound, where X₁, X₂ and X₃ are independently selected from the group consisting of a hydrogen, halogen atom, hydroxy, C1-C15 alky, C1-C15 alkoxy, C6-C20 aryl, C7-C25 alkylaryl and C7-C25 arylalkyl, hydrolysis, dehydration and polycondensation in the presence of an acid or base catalyst and water, to give a compound represented by Formula 1a or 1b.

In Formula 1a or 1b, R₁ and R₁₁ are groups derived from R₃′ of chlorotrialkoxysilane ClSi(OR₃′)₃, R₄′ of R₄′SiX₁X₂X₃ and the organometallic complex represented by Formula 14 or 15.

The organic electroluminescence device according to the present invention is manufactured by forming an organic layer, particularly a light-emitting layer, using the polysilsesquioxane-based compound represented by Formula 1a or 1b. The polysilsesquioxane-based compound represented by Formula 1a or 1b can be used as a material for forming a light-emitting layer, particularly, a blue light-emitting material. Also, the polysilsesquioxane-based compound can be used as a material for forming a organic layer such as a hole transport layer or an electron transport layer.

When the polysilsesquioxane-based compound represented by Formula 1a or 1b is used as a phospholuminescent dopant, the organic layer may further include at least one selected form the group consisting of a high molecular host, a high molecular and low molecular mixture host, a low molecular host, and a non-emitting high molecular matrix. Here, as the high molecular host, the low molecular host, and the non-emitting high molecular matrix, any host material that is commonly used in forming a light-emitting layer for an organic EL device, can be used. Examples of the high molecular host include, but are not limited to, poly(vinylcarbazole) (PVK), and polyfluorene, and examples of the low molecular host include, but are not limited to, CBP (4,4′-N,N′-dicarbazole-biphenyl), 4,4′-bis[9-(3,6-biphenylcarbazolyl)]-1-1,1′-biphenyl4,4′-bis[9-(3,6-biphenylcarzoly)]-1-1,1′-bi phenyl,9,10-bis[(2′,7′-t-butyl)-9′,9″-(spirobifluorenyl)anthracene, tetrafluorene. Examples of the non-emitting high molecular matrix include, but are not limited to, polymethylmethacrylate and polystyrene.

Preferably, the polysilsesquioxane-based compound represented by Formula 1a or 1b is contained in an amount of about 1 to 50 parts by weight based on 100 parts by weight of the total weight of the light-emitting layer forming material. Examples of methods useful to introduce the polysilsesquioxane-based compound to the light-emitting layer include vacuum deposition, sputtering, printing, coating, inkjet printing, electron-beam application, and so on. The polysilsesquioxane-based compound represented by Formula 1a or 1b can induce white electroluminescence when combined with green or red luminescent materials.

Here, the thickness of the organic layer is preferably in a range of about 30 to 100 nm. The term “organic layer” used herein means a layer made of an organic compound formed between a pair of electrodes in an organic electroluminescent device, for example, a light-emitting layer, an electron transport layer, a hole transport layer, and the like. The organic electroluminescent device has a known structure selected from the group consisting of anode/light-emitting layer/cathode, anode/buffer layer/light-emitting layer/cathode, anode/hole transport layer/light-emitting layer/cathode, anode/buffer layer/hole transport layer/light-emitting layer/cathode, anode/buffer layer/hole transport layer/light-emitting layer/electron transport layer/cathode, and anode/buffer layer/hole transport layer/light-emitting layer/hole blocking layer/cathode, but is not particularly limited to these structures. Examples of the buffer layer include any materials commonly used in the art, and preferred are copper phthalocyanine, polythiophene, polyaniline, polyacetylene, polypyrrole, polyphenylene vinylene, and derivatives thereof but not limited thereto. Examples of the hole transport layer include any materials commonly used in the art, and preferred is polytriphenylamine but not limited thereto. Examples of the electron transport layer include any materials commonly used in the art, and preferred is polyoxadiazole but not limited thereto. Examples of the hole blocking layer include any materials commonly used in the art, and preferred are LiF, BaF₂ or MgF₂ but not limited thereto.

The organic electroluminescence device according to the present invention can be manufactured in accordance with conventional apparatus and methods in the art without any limitations.

The polysilsesquioxane-based compound can emit light of wavelengths in a range from 400 to 650 nm. LEDs using such a polysilsesquioxane-based compound can be used in applications such as light sources for a full color display, backlighting, signboards, optical communication, indoor decoration, and the like.

Hereinafter, the present invention will now be described in more detail with reference to the following Examples. However, these examples are given for the purpose of illustration and not of limitation.

### EXAMPLE 1

### Synthesis OF F₂PPY Dimer

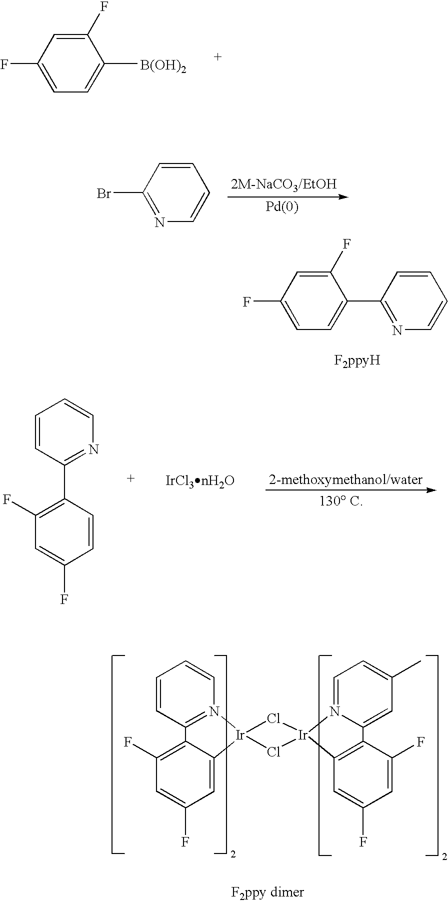

To a 500 mL branched flask was added a 2M aqueous solution of sodium carbonate solution prepared by mixing 19.85 g (1.25×104 mmol) of 2-bromopyridine, 25.00 g (1.58×104 mmol) of 2,4-difluorophenyl boronic acid, 100 mL toluene, 48 mL ethanol 48 mL and 95 mL water, and stirred under a nitrogen atmosphere at room temperature.

Then, to the reaction mixture was added 4.53 g (3.92 mmol) of tetrakis(triphenylphosphine) palladium(0) and refluxed for 15 hours under a nitrogen atmosphere with light shielded.

After the reaction was completed, the temperature of the reaction mixture was adjusted to room temperature, followed by extracting using ethyl acetate and water and isolating by column chromatography eluting with 10:1 volumetric ratio toluene/hexane, giving a pale brown liquid (F₂ ppyH).

2-(4,6-difluorophenylpyridine) obtained by the above, and IrCl3.nH2O were used to prepare a F₂ ppy dimer as a yellow powder. The preparation method was described in J. Am. Che. Soc., 1984, 106, 6647-6653 which is incorporated herein by reference. The product was identified through ¹H-NMR spectroscopy. ¹H-NMR(CD₂Cl₂, ppm): 9.1 [d, 4H], 8.3 [d, 4H], 7.9 [t, 4H], 6.9 [m, 4H], 6.5 [m, 4H], 5.3 [d, 4H].

### EXAMPLE 2

### Synthesis OF Fppy Dimer

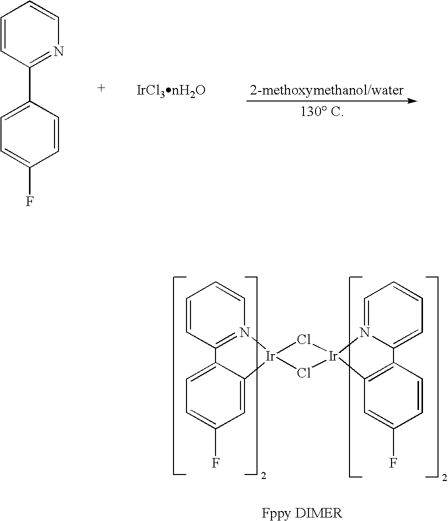

A Fppy dimer was synthesized by the same method as in Example 1 except that 4-fluorophenylboronic acid was used instead of 2,4-difluorophenylboronic acid.

¹H-NMR(CD₂Cl₂, ppm): 8.9 [d, 4H], 8.1 [s, 4H], 6.6 [d, 4H], 6.3 [m, 4H], 5.3 [d, 4H], 2.6 [s, 12H]

### EXAMPLE 3

### Synthesis OF F₂pmp Dimer

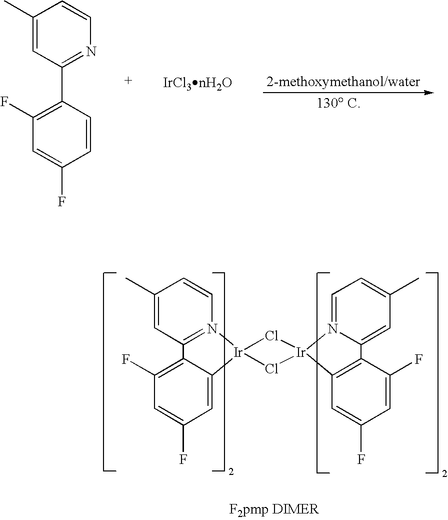

A F₂ pmp dimer was synthesized by the same method as in Example 1 except that 2-bromo 4-methylpyridine was used instead of 2-bromopyridine.

¹H-NMR(CD₂Cl₂, ppm): 8.9 [d, 4H], 8.1 [s, 4H], 6.6 [d, 4H], 6.3 [m, 4H], 5.3 [d, 4H], 2.6 [s, 12H]

### EXAMPLE 4

### Synthesis of DMAF₂ ppy Dimer

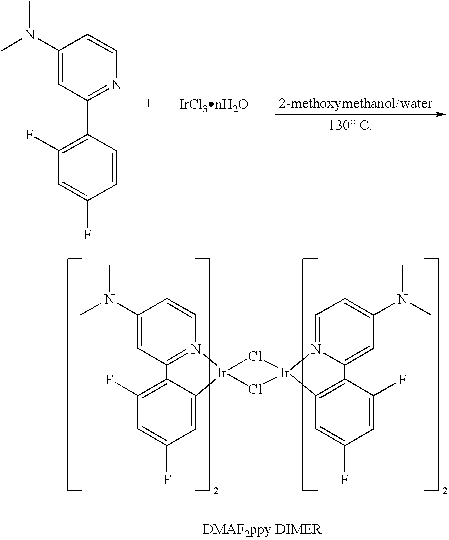

A DMAF₂ ppy dimer was synthesized by the same method as in Example 1 except that 2-bromo N,N′-dimethylpyridine was used instead of 2-bromo pyridine.

¹H-NMR(CD₂Cl₂, ppm): 8.7 [d, 4H], 7.5 [t, 4H], 6.3 [m, 4H], 6.1 [m, 4H], 5.4 [d, 4H], 3.2 [s, 24H]

### EXAMPLE 5

### Synthesis OF Polysilsesquioxane-Based Compound

To a 500 mL branched flask was added 10 g (0.147 mol) of pyrazole and dissolved in 300 mL of tetrahydrofuran. To the resultant product was slowly added 16.37 g (0.162 mol) of triethyl amine at 0° C. After about 10 minutes, 32.11 g (0.162 mol) of triethoxychlorosilane was slowly added thereto 0° C., and then reacted at room temperature for about 15 hours.

After the reaction was completed, the reaction mixture was filtered using a filter under a nitrogen atmosphere, to remove solid constituents from the resultant product to afford only liquid constituents. Then, only constituents that are volatile at a temperature of not greater than 200° C. were removed from the liquid constituents under reduced pressure. Thereafter, 200 ml of hexane was added to the reactant product, stirred at room temperature for about one hour, filtered fine solid constituents to be removed, followed by removing only volatile constituents under reduced pressure, thereby synthesizing a pyrazole compound (A) having a triethoxysilyl group:

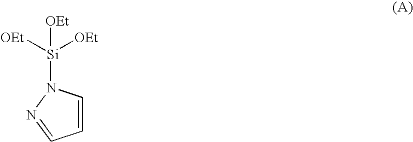

0.00434 mol of the compound (A) and 9 g (0.07365 mol) of methyltrimethoxysilane were added to a 100 ml flask under nitrogen atmosphere. Then, 4.4 ml of a diluted aqueous solution of hydrochloric acid obtained by mixing 0.001021 mol of hydrochloric acid with 1 ml of deionized water was transferred to the flask and stirred at room temperature for 20 minutes. Thereafter, a mixed solution of 100 ml of tetrahydrofuran and 50 ml of diethylether 50 ml was added to the reactant product and stirred for 10 minutes, and the resultant solution was transferred to a separatory funnel and washed with 20 ml of deionized water three times, followed by adding 10 g of anhydrous sodium sulfate thereto and storing the resultant product at low temperature overnight to be evaporated. The resultant product was filtered to remove only solid constituents, and volatile materials contained in liquid constituents were removed under reduced pressure, thereby synthesizing a pyrazole containing compound having ligands capable of having organometallic complex coordinated to the side chain of polysilsesquioxane. To 1 g of the pyrazole containing compound was added 0.1 g of Fppy dimer, 20 ml of tetrahydrofuran was added thereto and reacted while stirring at room temperature for 15 hours. After the reaction is completed, the reaction mixture was passed through a pad of celite for filtration, giving yellow powder.

The compound was dissolved in 10 ml of tetrahydrofuran, and the resultant solution was passed through a 0.2 μm filter to remove fine solid constituents, followed by removing volatile constituents under reduced pressure, yielding a polysilsesquioxane-based compound. The polysilsesquioxane-based compound has a structure in which —CH₃, —OCH₂CH₃, —OH, pyrazole, or a group represented by Formula 4 is linked to Si of SiO_{1.5}.

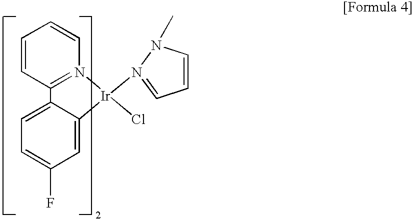

Emission characteristics of the obtained polysilsesquioxane-based compound were evaluated by dissolving the compound in a methylenechloride solution. The evaluation result showed that the compound had an emission wavelength peak at 483 nm. Also, the CIE (Commission Internationale de l'Eclairage) color coordinate (x, y) of the compound was (0.165, 0.444).

### EXAMPLE 6

### Synthesis of Polysilsesquioxane-Based Compound

The polysilsesquioxane-based compound was synthesized in the same manner as in Example 5, except that F₂ ppy dimer, instead of Fppy dimer, was used.

The polysilsesquioxane-based compound has a structure in which —CH3, —OCH2CH3, —OH, pyrazole group, or a group represented by Formula 5 is linked to Si of a SiO_{1.5} bond.

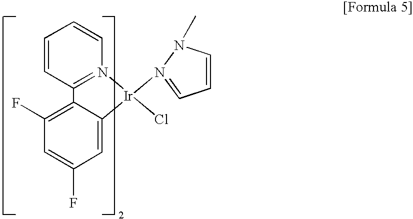

Emission characteristics of the obtained polysilsesquioxane-based compound were evaluated by dissolving the compound in a methylenechloride solution. The evaluation result showed that the compound had an emission wavelength peak at 472 nm. Also, the CIE color coordinate (x, y) of the compound was (0.141, 0.236).

### EXAMPLE 7

### Synthesis OF Polysilsesquioxane-Based Compound

The polysilsesquioxane-based compound was synthesized in the same manner as in Example 5, except that F₂ pmp dimer, instead of Fppy dimer, was used.

The polysilsesquioxane-based compound has a structure in which —CH3, —OCH2CH3, —OH, pyrazole group, or a group represented by Formula 6 is linked to Si of a SiO1.5 bond. 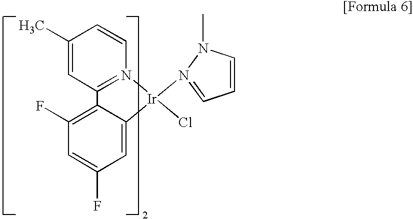
Emission characteristics of the obtained polysilsesquioxane-based compound were evaluated by dissolving the compound in a methylenechloride solution. The evaluation result showed that the compound had an emission wavelength peak at 468 nm. Also, the CIE color coordinate (x, y) of the compound was (0.144, 0.206).

### EXAMPLE 8

### Synthesis of Polysilsesquioxane-Based Compound

The polysilsesquioxane-based compound was synthesized in the same manner as in Example 5, except that DMAF₂ pmp dimer, instead of Fppy dimer, was used.

The polysilsesquioxane-based compound has a structure in which —CH₃, —OCH₂CH₃, —OH, pyrazole group, or a group represented by Formula 7 is linked to Si of a SiO_{1.5} bond.

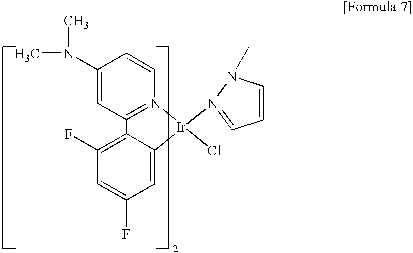

Emission characteristics of the obtained polysilsesquioxane-based compound were evaluated by dissolving the compound in a methylenechloride solution. The evaluation result showed that the compound had an emission wavelength peak at 458 nm. Also, the CIE color coordinate (x, y) of the compound was (0.144, 0.186).

### EXAMPLE 9

### Synthesis of Polysilsesquioxane-Based Compound

The polysilsesquioxane-based compound was synthesized in the same manner as in Example 5, except that 4-pyridinemethanol, instead of pyrazole, was used.

The polysilsesquioxane-based compound has a structure in which —CH₃, —OCH₂CH₃, —OH, 4-pyridinemethanol group, or a group represented by Formula 8 is linked to Si of a SiO_{1.5} bond.

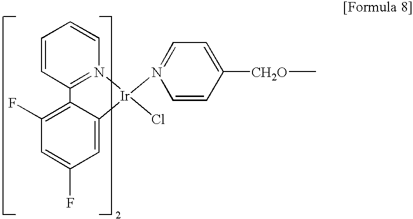

Emission characteristics of the obtained polysilsesquioxane-based compound were evaluated by dissolving the compound in a methylenechloride solution. The evaluation result showed that the compound had an emission wavelength peak at 471 nm. Also, the CIE color coordinate (x, y) of the compound was (0.147, 0.315).

### EXAMPLE 10

### Synthesis of Polysilsesquioxane-Based Compound

The polysilsesquioxane-based compound was synthesized in the same manner as in Example 5, except that F₂ pmp dimer was used instead of Fppy dimer and imidazole was used instead of pyrazole.

The polysilsesquioxane-based compound has a structure in which —CH₃, —OCH₂CH₃, —OH, imidazole group, or a group represented by Formula 9 is linked to Si of a SiO_{1.5} bond.

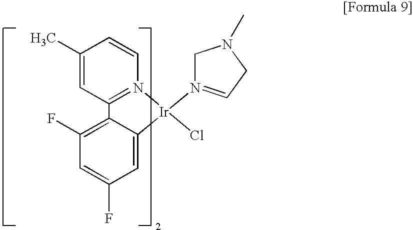

Emission characteristics of the obtained polysilsesquioxane-based compound were evaluated by dissolving the compound in a methylenechloride solution. The evaluation result showed that the compound had an emission wavelength peak at 474 nm. Also, the CIE color coordinate (x, y) of the compound was (0.145, 0.326).

### EXAMPLE 11

### Synthesis of Polysilsesquioxane-Based Compound

The polysilsesquioxane-based compound was synthesized in the same manner as in Example 5, except that F2 pmp dimer was used instead of Fppy dimer and 4-hydroxyphenylacetylacetonate was used instead of pyrazole.

The polysilsesquioxane-based compound has a structure in which —CH₃, —OCH₂CH₃, —OH, 4-hydroxyphenylacetylacetonate group, or a group represented by Formula 10 is linked to Si of a SiO_{1.5} bond.

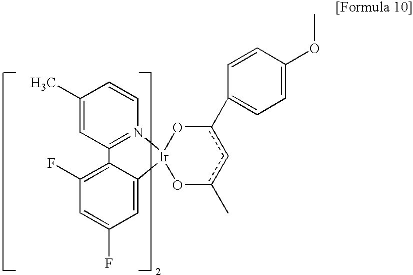

Emission characteristics of the obtained polysilsesquioxane-based compound were evaluated by dissolving the compound in a methylenechloride solution. The evaluation result showed that the compound had an emission wavelength peak at 555 nm. Also, the CIE color coordinate (x, y) of the compound was (0.445, 0.556).

### EXAMPLE 12

### Synthesis of Polysilsesquioxane-Based Compound

To a 500 mL branched flask was added 10 g (0.147 mol) of pyrazole and dissolved in 300 mL of tetrahydrofuran. To the resultant product was slowly added 16.37 g (0.162 mol) of triethyl amine at 0° C. After about 10 minutes, 32.11 g (0.162 mol) of triethoxychlorosilane was slowly added thereto 0° C., and then reacted at room temperature for about 15 hours.

After the reaction was completed, the reaction mixture was filtered using a filter under a nitrogen atmosphere, to remove solid constituents from the resultant product to afford only liquid constituents. Then, only volatile constituents were removed from the liquid constituents under reduced pressure. Thereafter, 200 ml of hexane was added to the reactant product, stirred at room temperature for about one hour, filtered fine solid constituents to be removed, followed by removing only volatile constituents under reduced pressure, thereby synthesizing a pyrazole compound (A) having a triethoxysilyl group

0.250 mmol of the compound and 30 ml of methylene chloride was added to a 250 ml branched flask under nitrogen atmosphere, 0.5 mmol of F2 pmp dimer was added thereto and reacted at room temperature for 1 hours. After the reaction was completed, the reaction mixture was passed through a pad of celite for filtration and precipitated in 100 ml of hexane, giving an organometallic complex having a ligand substituted with trilethoxysilyl group. Thereafter, 1.17 mmol and 0.07365 mol of methyltrimethoxysilane were added to 100 ml flask under a nitrogen atmosphere. Thereafter, 2 ml of a diluted aqueous solution of hydrochloric acid obtained by mixing 0.001021 mol of hydrochloric acid with 1 ml of deionized water was transferred to the flask and stirred at room temperature for 20 minutes. Thereafter, a mixed solution of 100 ml of tetrahydrofuran and 50 ml of diethylether 50 ml was added to the reactant product and stirred for 10 minutes, and the resultant solution was transferred to a separatory funnel and washed with 20 ml of deionized water three times, followed by adding 10 g of anhydrous sodium sulfate thereto and storing the resultant product at low temperature overnight to be evaporated. The resultant compound was filtered to remove only solid constituents to afford liquid constituents, and volatile materials contained in the liquid constituents were removed under under reduced pressure. The compound was dissolved in 10 ml of tetrahydrofuran, and the resultant solution was passed through a 0.2 μm filter to remove fine solid constituents, followed by removing volatile constituents under reduced pressure, yielding a polysilsesquioxane-based compound. The polysilsesquioxane-based compound has the same structure as in Example 7.

Emission characteristics of the obtained polysilsesquioxane-based compound were evaluated by dissolving the compound in a methylenechloride solution. The evaluation result showed that the compound had an emission wavelength peak at 468 nm. Also, the CIE color coordinate (x, y) of the compound was (0.144, 0.207).

### EXAMPLE 13

### Manufacture of Organic Electroluminescence Device

An ITO substrate (10 Ω/cm²) was used as an anode, PEDOT (poly(3, 4-ethylenedioxythiophene)) was spin coated on the substrate to form a hole injection layer to a thickness of 500 Å. The hole injection layer was spin coated with 70 parts by weight of polysilsesquioxane-based compound prepared in Example 7 and 30 parts by weight of CBP (4,4′-bis(carbazol-9-yl)-biphenyl) having the following structure, thereby forming an emission layer to a thickness of 300 Å.

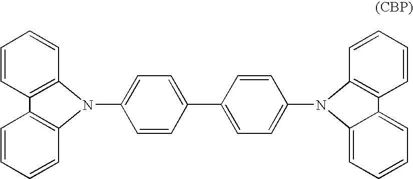

Then, bis(2-methyl-8-quinolinolato)(4-phenylphenolato)aluminum (BAlq₂) used for transporting electrons and blocking holes was vacuum-deposited on the emission layer to form a layer having a thickness of 400 Å. LiF 10 Å thick LiF and 1000 Å thick Al were sequentially vacuum-deposited on the resultant layer to form LiF/Al electrodes, thereby completing an organic electroluminescence device.

The organic electroluminescence device manufactured in Example 12 was tested for evaluation of CIE color coordinate, emission efficiency and emission profile characteristics.

The CIE color coordinate (x, y) of the electroluminescence device was (0.198, 0.326), the emission efficiency was 0.34 cd/A @10.0V, and the maximum emission peak was 480 nm.

The electroluminescent substance having an organometallic complex bonded to a side chain of polysilsesquioxane can efficiently emit light of wavelengths from a blue range to a red range using triplet MLCT can efficiently emit light of wavelengths from a blue range to a red range using triplet MLCT. The electroluminescent substance, which is a highly efficient phospholuminescent material, can be suitably used for forming an organic layer of the organic electroluminescent device, and can emit light in a wavelength range of 400-650 nm. Also, it can induce white electroluminescence when combined with green or red luminescent materials.

The electroluminescent substance having an organometallic complex bonded to a side chain of polysilsesquioxane according to the present invention can be used in forming an organic layer in an organic electroluminescent device.

1. A polysilsesquinone-based compound having a unit represented by Formula 1a:
—(R₁₁SiO_{1.5})ₙ— (1a)
wherein R₁₁ represents an organometallic complex-containing group having a metal selected from the group consisting of Ir, Os, Pt, Pb, Re, Ru and Pd; and
n is an integer not less than 2.

2. The polysilsesquinone-based compound of claim 1, wherein the compound further comprises a —(R₁SiO_{1.5})ₐ— repeating unit and represented by Formula 1b:
—[—(R₁SiO_{1.5})ₐ—(R₁₁SiO_{1.5})_{b}—]ₙ— (1b)
wherein R₁ is independently selected from the group consisting of a hydrogen atom, a hydroxy group, a C1-C15 alkyl group, a C1-C15 alkoxy group, a C6-C20 aryl group, a C7-C25 alkylaryl group and a C7-C25 arylalkyl group;
R₁₁ represents an organometallic complex-containing group having a metal selected from the group consisting of Ir, Os, Pt, Pb, Re, Ru and Pd;
n is an integer not less than 2; and
a mixing molar ratio of a and b is 1:99 to 99:1.

3. The polysilsesquinone-based compound of claim 1, wherein the organometallic complex-containing group is represented by one of Formulas 2 and 3: 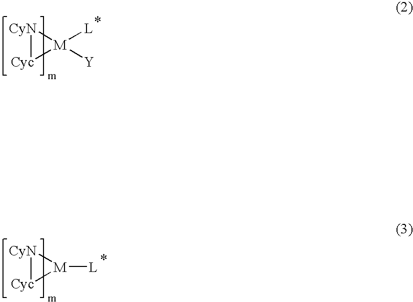
wherein M is selected from the group consisting of Ir, Os, Pt, Pb, Re, Ru and Pd;
CyN is a substituted or unsubstituted C3-C60 heterocyclic group containing nitrogen bonded to M, or a substituted or unsubstituted C3-C60 heteroaryl group containing nitrogen bonded to M;
CyC is selected from the group consisting of a substituted or unsubstituted 4 to 60 carbocyclic group containing carbon bonded to M, a substituted or unsubstituted C3-C60 heterocyclic group containing carbon bonded to M, a substituted or unsubstituted C3-C60 aryl group containing carbon bonded to M and a substituted or unsubstituted C3-C60 heteroaryl group containing carbon bonded to M;
CyN-CyC represents a cyclometalating ligand bonded to M through nitrogen (N) and carbon (C);
L is a monodentate ligand or a bidentate ligand;
Y is a monoanionic ligand or a monodentate ligand;
m is 1 or 2; and
the asterisk mark, *, represents a bonding position for Si.

4. The polysilsesquinone-based compound of claim 2, wherein the organometallic complex-containing group is represented by one of Formulas 2 and 3: 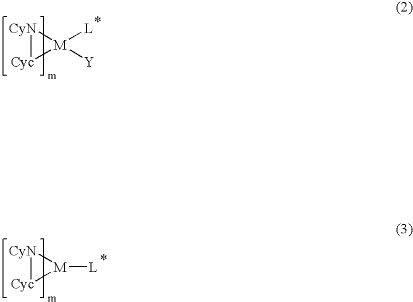
wherein M is selected from the group consisting of Ir, Os, Pt, Pb, Re, Ru and Pd;
CyN is a substituted or unsubstituted C3-C60 heterocyclic group containing nitrogen bonded to M, or a substituted or unsubstituted C3-C60 heteroaryl group containing nitrogen bonded to M;
CyC is selected from the group consisting of a substituted or unsubstituted 4 to 60 carbocyclic group containing carbon bonded to M, a substituted or unsubstituted C3-C60 heterocyclic group containing carbon bonded to M, a substituted or unsubstituted C3-C60 aryl group containing carbon bonded to M and a substituted or unsubstituted C3-C60 heteroaryl group containing carbon bonded to M;
CyN-CyC represents a cyclometalating ligand bonded to M through nitrogen (N) and carbon (C);
L is a monodentate ligand or a bidentate ligand;
Y is a monoanionic ligand or a monodentate ligand;
m is 1 or 2; and
the asterisk mark, *, represents a bonding position for Si.

5. The polysilsesquinone-based compound of claim 3, wherein the CyN-CyC is represented by one of the following formulas (a) through (p): 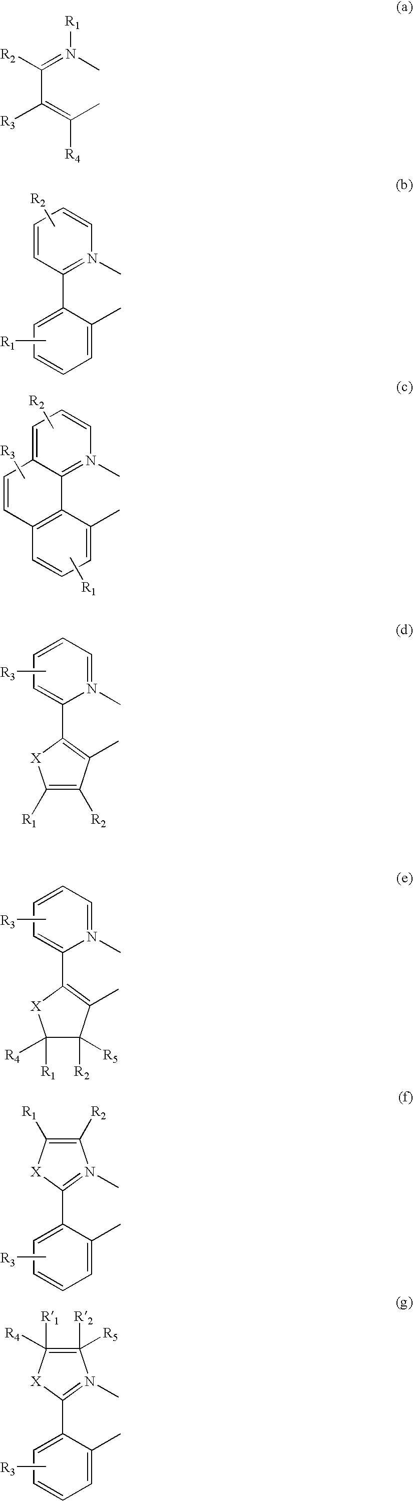 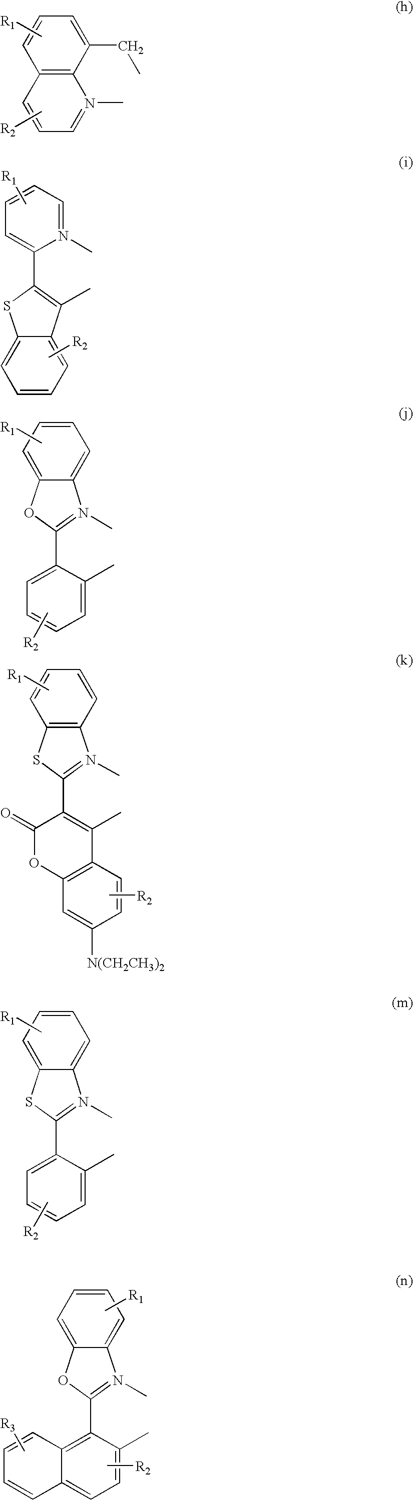 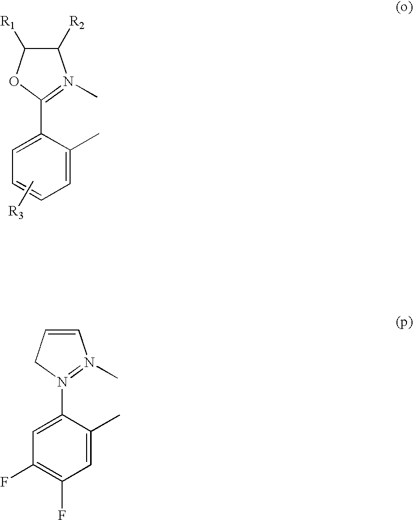
wherein L is one of a ligand represented by one of the following formulas (q) through (z), and (a′) through (p′) and a substituted or unsubstitued derivative of one selected from the group consisting of a substituted or unsubstitued triethylamine, a substituted or unsubstitued propylamine, a substituted or unsubstittued cyclohexylamine, a substituted or unsubstitued pyrrolidine, a substituted or unsubstitued pyrroline, a substituted or unsubstitued piperidine, a substituted or unsubstitued pyrimidine, a substituted or unsubstitued indole, a substituted or unsubstitued azaindole, a substituted or unsubstitued carbazole, a substituted or unsubstitued indazole, a substituted or unsubstitued norharman, a substituted or unsubstitued harman, a substituted or unsubstitued aniline, a substituted or unsubstitued imidazole, a substituted or unsubstitued oxazole, a substituted or unsubstitued thiazole, a substituted or unsubstitued pyrazole, a substituted or unsubstitued pyrrole, a substituted or unsubstitued benzimidazole, a substituted or unsubstitued benzotriazole, a substituted or unsubstitued benzoxazole, a substituted or unsubstitued benzothiazole, a substituted or unsubstitued benzoselenazole, a substituted or unsubstitued benzothiadiazole, a substituted or unsubstitued isoxazole, a substituted or unsubstitued isothiazole, a substituted or unsubstitued oxadiazole, a substituted or unsubstitued thiadiazole, a substituted or unsubstitued anthranyl, a substituted or unsubstitued triazine, a substituted or unsubstitued benzisoxazole, a substituted or unsubstitued pyrazine, a substituted or unsubstitued quinoline, a substituted or unsubstitued benzoquinoline, a substituted or unsubstitued acridine, a substituted or unsubstitued thiazoline, a substituted or unsubstitued quinuclidine, a substituted or unsubstitued imidazoline, a substituted or unsubstitued oxazoline, a substituted or unsubstitued thiazoline, and a substituted or unsubstitued isoquinoline; and
Y is —F, —Cl, —Br, —I, —CN, —CN(R′″), —SCN or —OCN, where R′″ is a substituted or unsubstituted C1-C20 alkyl group: 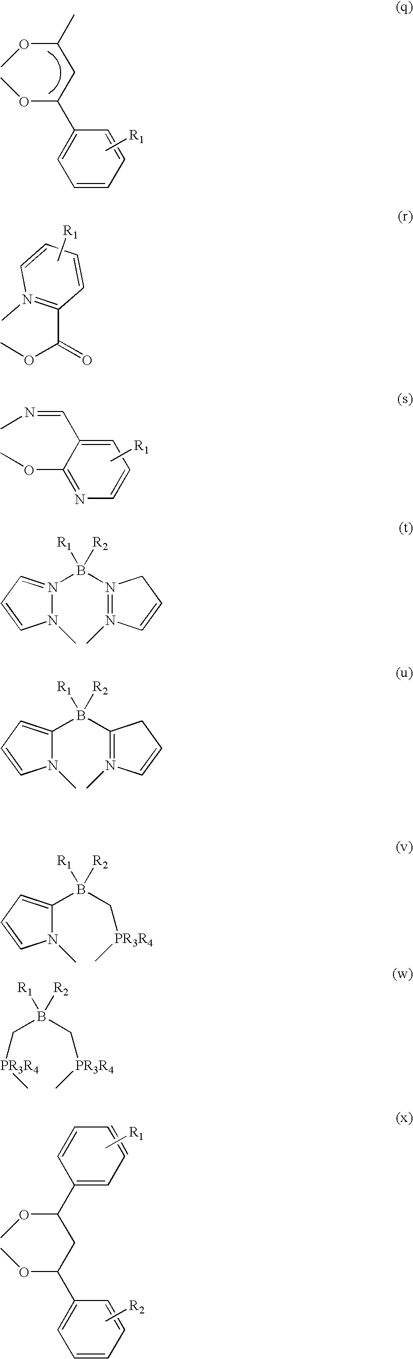 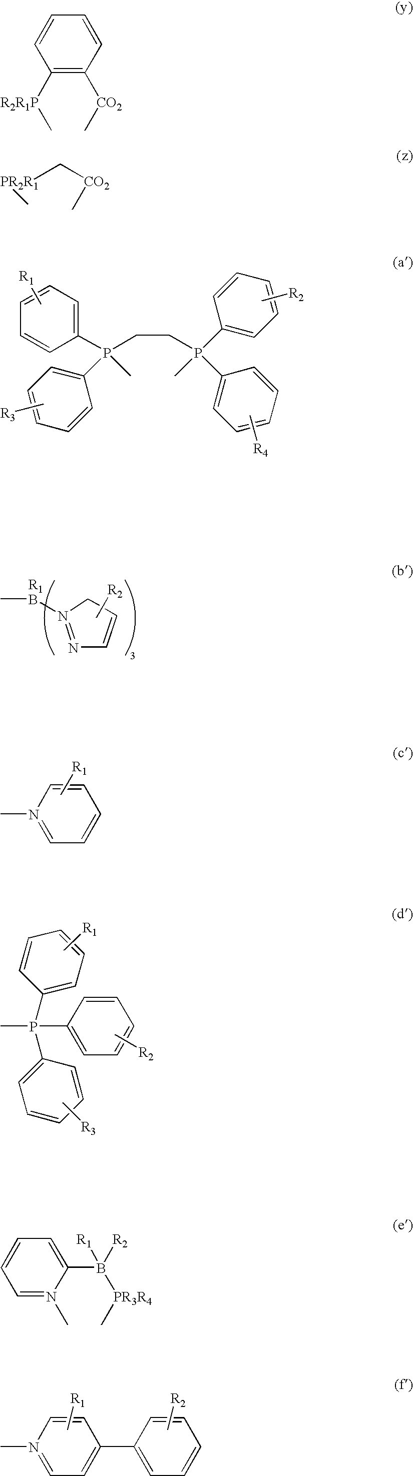 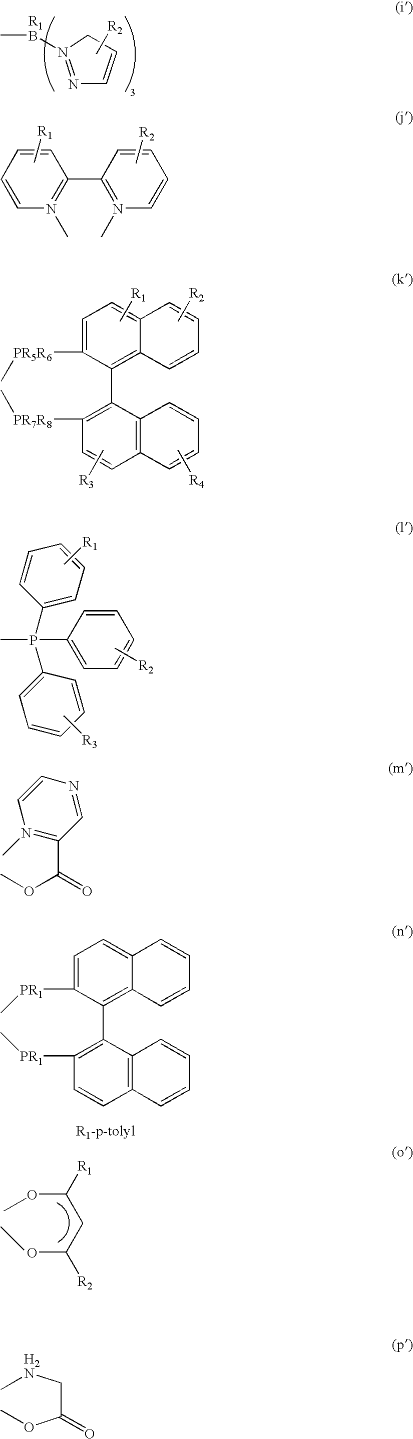
wherein R₁, R₂, R₃, R₄, R₅, R₆, R₇ and R₈ are each independently a monosubstituted or multisubstituted substituent, and are each selected from the group consisting of hydrogen, a halogen atom, —OR′, —N(R′)₂, —P(R′)₂, —POR′, —PO₂R′, —PO₃R′, —SR′, —Si(R′)₃, —B(R′)₂, —B(OR′)₂, —C(O)R′, —C(O)OR′, —C(O)N(R′), —CN, —NO₂, —SO₂, —SOR, —SO₂R′, —SO₃R′, C1-C20 alkyl, and C6-C20 aryl, where R′ is selected from the group consisting of a hydrogen atom, a substituted or unsubstituted C1-C20 alkyl, substituted or unsubstituted C1-C10 alkoxy, substituted or unsubstituted C2-C20 alkenyl, substituted or unsubstituted C2-C20 alkynyl, substituted or unsubstituted C1-C20 heteroalkyl, substituted or unsubstituted C6-C40 aryl, substituted or unsubstituted C7-C40 arylalkyl, substituted or unsubstituted C7-C40 alkylaryl, substituted or unsubstituted C2-C40 heteroaryl, and substituted or unsubstituted C3-C40 heteroarylalkyl;
X is CH, S, O or NR″, where R″ is a hydrogen atom or a C1-C20 alkyl group; and
E is O, S, Se or Te.

6. The polysilsesquinone-based compound of claim 4, wherein the CyN-CyC is represented by one of the following formulas (a) through (p): 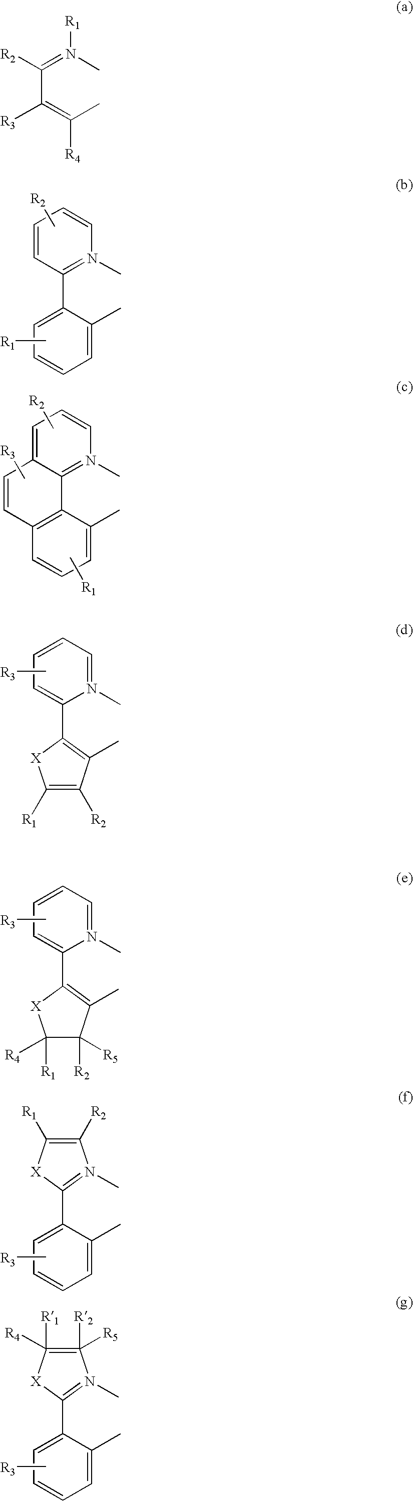 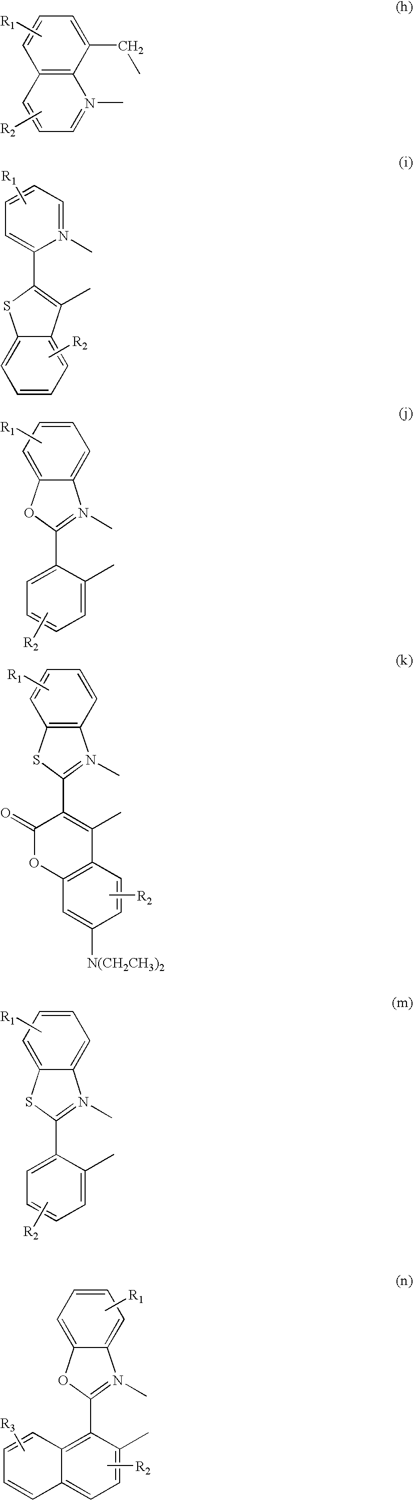 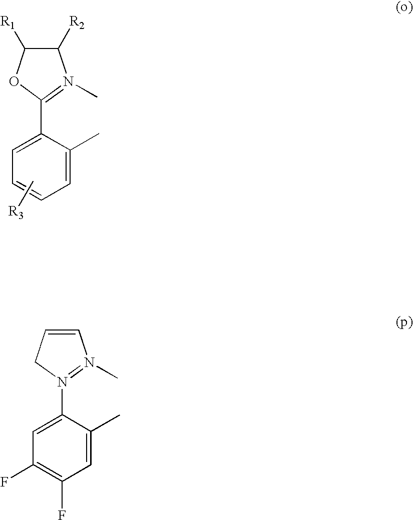
wherein L is one of a ligand represented by one of the following formulas (q) through (z), and (a′) through (p′) and a substituted or unsubstitued derivative of one selected from the group consisting of a substituted or unsubstitued triethylamine, a substituted or unsubstitued propylamine, a substituted or unsubstittued cyclohexylamine, a substituted or unsubstitued pyrrolidine, a substituted or unsubstitued pyrroline, a substituted or unsubstitued piperidine, a substituted or unsubstitued pyrimidine, a substituted or unsubstitued indole, a substituted or unsubstitued azaindole, a substituted or unsubstitued carbazole, a substituted or unsubstitued indazole, a substituted or unsubstitued norharman, a substituted or unsubstitued harman, a substituted or unsubstitued aniline, a substituted or unsubstitued imidazole, a substituted or unsubstitued oxazole, a substituted or unsubstitued thiazole, a substituted or unsubstitued pyrazole, a substituted or unsubstitued pyrrole, a substituted or unsubstitued benzimidazole, a substituted or unsubstitued benzotriazole, a substituted or unsubstitued benzoxazole, a substituted or unsubstitued benzothiazole, a substituted or unsubstitued benzoselenazole, a substituted or unsubstitued benzothiadiazole, a substituted or unsubstitued isoxazole, a substituted or unsubstitued isothiazole, a substituted or unsubstitued oxadiazole, a substituted or unsubstitued thiadiazole, a substituted or unsubstitued anthranyl, a substituted or unsubstitued triazine, a substituted or unsubstitued benzisoxazole, a substituted or unsubstitued pyrazine, a substituted or unsubstitued quinoline, a substituted or unsubstitued benzoquinoline, a substituted or unsubstitued acridine, a substituted or unsubstitued thiazoline, a substituted or unsubstitued quinuclidine, a substituted or unsubstitued imidazoline, a substituted or unsubstitued oxazoline, a substituted or unsubstitued thiazoline, and a substituted or unsubstitued isoquinoline; and
Y is —F, —Cl, —Br, —I, —CN, —CN(R′″), —SCN or —OCN, where R′″ is a substituted or unsubstituted C1-C20 alkyl group: 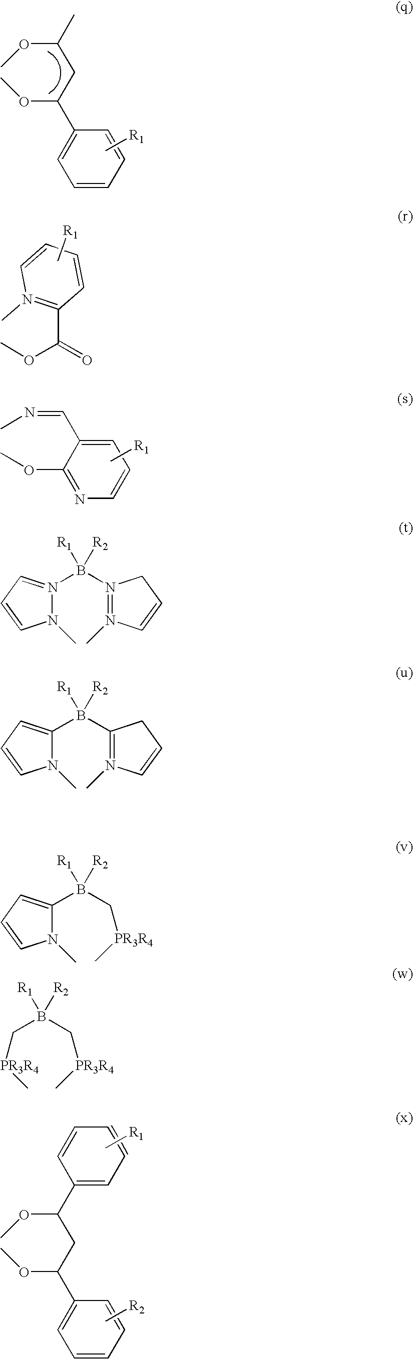 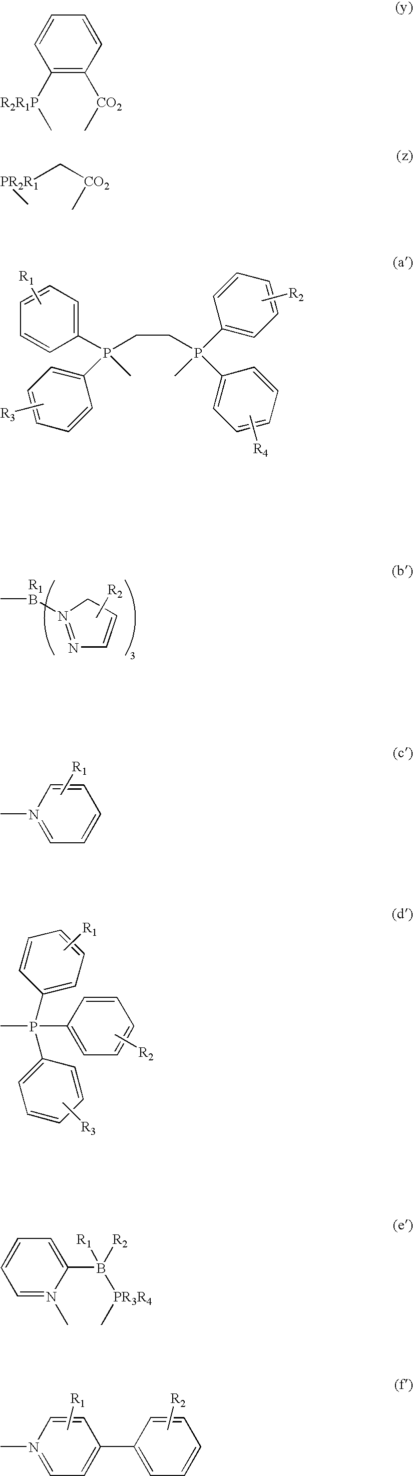 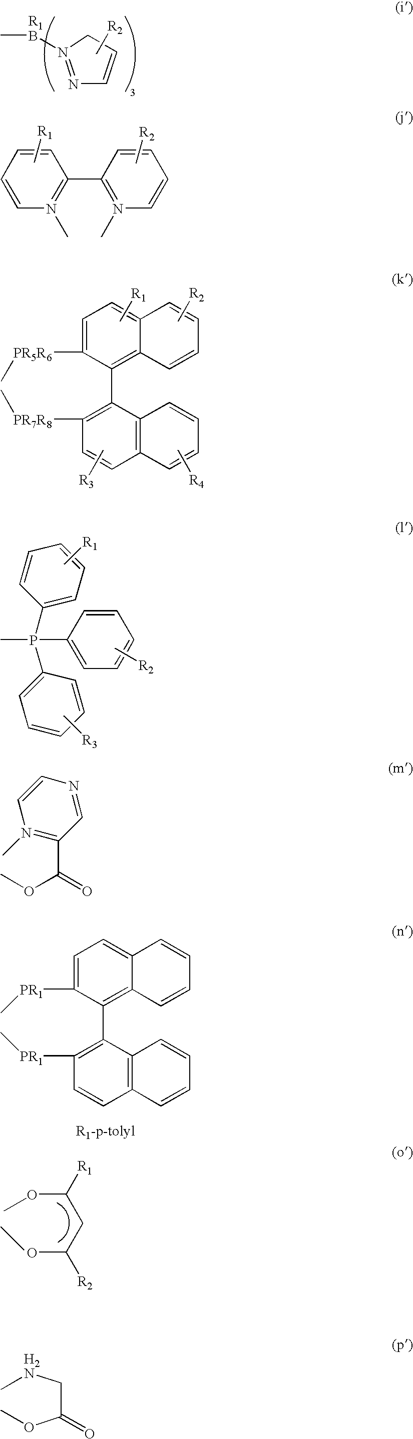
wherein R₁, R₂, R₃, R₄, R₅, R₇ and R₈ are each independently a monosubstituted or multisubstituted substituent, and are each selected from the group consisting of hydrogen, a halogen atom, —OR′, —N(R′)₂, —P(R′)₂, —POR′, —PO₂R′, —PO₃R′, —SR′, —Si(R′)₃, —B(R′)₂, —B(OR′)₂, —C(O)R′, —C(O)OR′, —C(O)N(R′), —CN, —NO₂, —SO₂, —SOR, —SO₂R′, —SO₃R′, C1-C20 alkyl, and C6-C20 aryl, where R′ is selected from the group consisting of a hydrogen atom, a substituted or unsubstituted C1-C20 alkyl, substituted or unsubstituted C1-C10 alkoxy, substituted or unsubstituted C2-C20 alkenyl, substituted or unsubstituted C2-C20 alkynyl, substituted or unsubstituted C1-C20 heteroalkyl, substituted or unsubstituted C6-C40 aryl, substituted or unsubstituted C7-C40 arylalkyl, substituted or unsubstituted C7-C40 alkylaryl, substituted or unsubstituted C2-C40 heteroaryl, and substituted or unsubstituted C3-C40 heteroarylalkyl;
X is CH, S, O or NR″, where R″ is a hydrogen atom or a C1-C20 alkyl group; and
E is O, S, Se or Te.

7. The polysilsesquinone-based compound of claim 5, wherein L is a ligand derived from one selected from the group consisting of pyrazole, 2-pyridinemethanol, imidazole, and 4-hydroxyphenylacetylacetonate.

8. The polysilsesquinone-based compound of claim 6, wherein L is a ligand derived from one selected from the group consisting of pyrazole, 2-pyridinemethanol, imidazole, and 4-hydroxyphenylacetylacetonate.

9. The polysilsesquinone-based compound of claim 1, wherein the compound is obtained by the process comprising the steps of:
reacting a compound containing a ligand of said L with chlorotrialkoxysilane ClSi(OR₃′)₃ where R3′ is a hydrogen atom or a C1-C15 alkyl to obtain a compound represented by Formula 11:
L-Si(OR₃′)₃ (11);
subjecting the compound represented by Formula 11 to, singly or in combination with, a R₄′SiX₁X₂X₃ compound, where X₁, X₂ and X₃ are each independently selected from the group consisting of a hydrogen, a halogen atom, hydroxy, C1-C15 alkyl, C1-C15 alkoxy, C6-C20 aryl, C7-C25 alkylaryl and C7-C25 arylalkyl, hydrolysis, dehydration and polycondensation in the presence of water and one of an acid catalyst and a base catalyst to obtain a compound represented by Formula 12a;
—[R₄′SiO_{1.5}]ₙ— (12a)
wherein R₄′ is selected from the group consisting of a hydrogen atom, a halogen atom, hydroxy, C1-C15 alkyl, C1-C15 alkoxy, C6-C20 aryl, C7-C25 alkylaryl and C7-C25 arylalkyl;
n is a number greater than or equal to 2; and
reacting the compound of Formula 12a with the organometallic complex represented by one of Formulae 13 and 14: 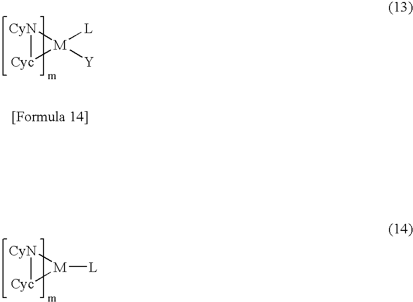
wherein M is selected from the group consisting of Ir, Os, Pt, Pb, Re, Ru and Pd;
CyN is a substituted or unsubstituted C3-C60 heterocyclic group containing nitrogen bonded to M, or a substituted or unsubstituted C3-C60 heteroaryl group containing nitrogen bonded to M;
CyC is selected from the group consisting of a substituted or unsubstituted 4 to 60 carbocyclic group containing carbon bonded to M, substituted or unsubstituted C3-C60 heterocyclic group containing carbon bonded to M, a substituted or unsubstituted C3-C60 aryl group containing carbon bonded to M and a substituted or unsubstituted C3-C60 heteroaryl group containing carbon bonded to M;
CyN-CyC represents a cyclometalating ligand bonded to M through nitrogen (N) and carbon (C);
L is a monodentate ligand or a bidentate ligand;
Y is a monoanionic ligand or a monodentate ligand; and
m is 1 or 2.

10. The polysilsesquinone-based compound of claim 2, wherein the compound is obtained by the process comprising the steps of:
reacting a compound containing a ligand of said L with chlorotrialkoxysilane ClSi(OR₃′)₃ where R3′ is a hydrogen atom or a C1-C15 alkyl to obtain a compound represented by Formula 11:
L-Si(OR₃′)₃ (11);
subjecting the compound represented by Formula 11 to, singly or in combination with, a R₄′SiX₁X₂X₃ compound, where X₁, X₂ and X₃ are each independently selected from the group consisting of a hydrogen, a halogen atom, hydroxy, C1-C15 alkyl, C1-C15 alkoxy, C6-C20 aryl, C7-C25 alkylaryl and C7-C25 arylalkyl, hydrolysis, dehydration and polycondensation in the presence of water and one of an acid catalyst and a base catalyst to obtain a compound represented by Formula 12b;
-[-(LSiO_{1.5})ₐ—(R4′SiO_{1.5})_{b}—]ₙ— (12 b)
wherein R₄′ is selected from the group consisting of a hydrogen atom, a halogen atom, hydroxy, C1-C15 alkyl, C1-C15 alkoxy, C6-C20 aryl, C7-C25 alkylaryl and C7-C25 arylalkyl;
L is a ligand represented by (q) through (z) and (a′) through (p′);
n is a number greater than or equal to 2; and
a mixing molar ratio of a and b is 1:99 to 99:1; and
reacting the compound of Formula 12b with the organometallic complex represented by one of Formulae 13 and 14: 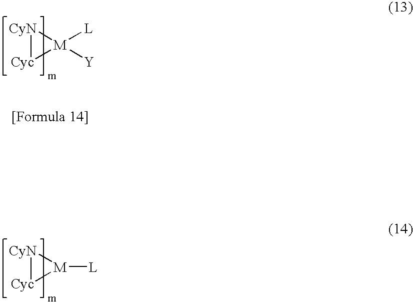
wherein M is selected from the group consisting of Ir, Os, Pt, Pb, Re, Ru and Pd;
CyN is a substituted or unsubstituted C3-C60 heterocyclic group containing nitrogen bonded to M, or a substituted or unsubstituted C3-C60 heteroaryl group containing nitrogen bonded to M;
CyC is selected from the group consisting of a substituted or unsubstituted 4 to 60 carbocyclic group containing carbon bonded to M, substituted or unsubstituted C3-C60 heterocyclic group containing carbon bonded to M, a substituted or unsubstituted C3-C60 aryl group containing carbon bonded to M and a substituted or unsubstituted C3-C60 heteroaryl group containing carbon bonded to M;
CyN-CyC represents a cyclometalating ligand bonded to M through nitrogen (N) and carbon (C);
L is a monodentate ligand or a bidentate ligand;
Y is a monoanionic ligand or a monodentate ligand; and
m is 1 or 2.

11. The polysilsesquinone-based compound of claim 9, wherein the compound is obtained by the process comprising the steps of:
reacting the organometallic complex represented by one of Formulae 13 and 14 with chlorotrialkoxysilane (ClSi(OR₃′)₃ wherein R₃′ is a hydrogen atom or a C1-C15 alkyl group to obtain a compound represented by one of Formulae 15 and 16: 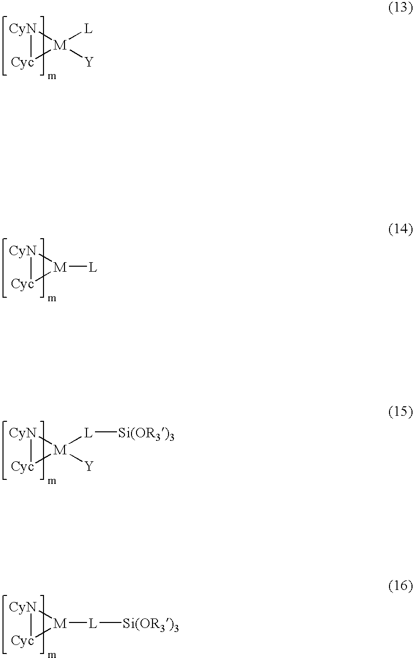
wherein M is selected from the group consisting of Ir, Os, Pt, Pb, Re, Ru and Pd;
CyN is a substituted or unsubstituted C3-C60 heterocyclic group containing nitrogen bonded to M, or a substituted or unsubstituted C3-C60 heteroaryl group containing nitrogen bonded to M;
CyC is selected from the group consisting of a substituted or unsubstituted 4 to 60 carbocyclic group containing carbon bonded to M, substituted or unsubstituted C3-C60 heterocyclic group containing carbon bonded to M, a substituted or unsubstituted C3-C60 aryl group containing carbon bonded to M and a substituted or unsubstituted C3-C60 heteroaryl group containing carbon bonded to M;
CyN-CyC represents a cyclometalating ligand bonded to M through nitrogen (N) and carbon (C);
L is a monodentate ligand or a bidentate ligand;
Y is a monoanionic ligand or a monodentate ligand; and
m is 1 or 2; and
subjecting the compound represented by one of Formulae 15 and 16 to, singly or in combination with R₄′SiX₁X₂X₃ compound where X₁, X₂ and X₃ are independently selected from the group consisting of a hydrogen atom, a halogen atom, hydroxy, C1-C15 alkyl, C1-C15 alkoxy, C6-C20 aryl, C7-C25 alkylaryl and C7-C25 arylalkyl, hydrolysis, dehydration and polycondensation in the presence of one of an acid catalyst and a base catalyst and water.

12. The polysilsesquinone-based compound of claim 10, wherein the compound is obtained by the process comprising the steps of:
reacting the organometallic complex represented by one of Formulae 13 and 14 with chlorotrialkoxysilane (ClSi(OR₃′)₃ wherein R₃′ is a hydrogen atom or a C1-C15 alkyl group to obtain a compound represented by one of Formulae 15 and 16: 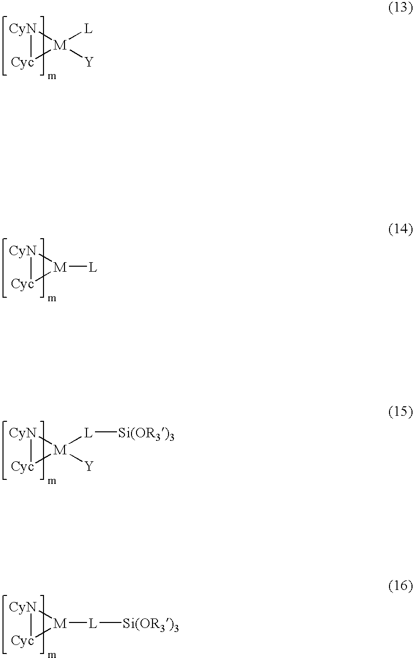
wherein M is selected from the group consisting of Ir, Os, Pt, Pb, Re, Ru and Pd;
CyN is a substituted or unsubstituted C3-C60 heterocyclic group containing nitrogen bonded to M, or a substituted or unsubstituted C3-C60 heteroaryl group containing nitrogen bonded to M;
CyC is selected from the group consisting of a substituted or unsubstituted 4 to 60 carbocyclic group containing carbon bonded to M, substituted or unsubstituted C3-C60 heterocyclic group containing carbon bonded to M, a substituted or unsubstituted C3-C60 aryl group containing carbon bonded to M and a substituted or unsubstituted C3-C60 heteroaryl group containing carbon bonded to M;
CyN-CyC represents a cyclometalating ligand bonded to M through nitrogen (N) and carbon (C);
L is a monodentate ligand or a bidentate ligand;
Y is a monoanionic ligand or a monodentate ligand; and
m is 1 or 2; and
subjecting the compound represented by one of Formulae 15 and 16 to, singly or in combination with R₄′SiX₁X₂X₃ compound where X₁, X₂ and X₃ are independently selected from the group consisting of a hydrogen atom, a halogen atom, hydroxy, C1-C15 alkyl, C1-C15 alkoxy, C6-C20 aryl, C7-C25 alkylaryl and C7-C25 arylalkyl, hydrolysis, dehydration and polycondensation in the presence of one of an acid catalyst and a base catalyst and water.

13. An organic electroluminescent device comprising an organic layer containing the polysilsesquinone-based compound of claim 1 between a pair of electrodes.

14. An organic electroluminescent device comprising an organic layer containing the polysilsesquinone-based compound of claim 2 between a pair of electrodes.

15. An organic electroluminescent device, comprising:
a pair of electrodes; and
an organic layer between said pair of electrodes, the organic layer comprising a polysilsesquinone-based compound represented by Formula 1a:
—(R₁₁SiO_{1.5})ₙ— (1a)
wherein R₁₁ represents an organometallic complex-containing group having a metal selected from the group consisting of Ir, Os, Pt, Pb, Re, Ru and Pd; and
n is an integer not less than 2.

16. The organic electroluminescent device of claim 1, wherein the polysilsesquinone-based compound further comprises a —(R₁SiO_{1.5})ₐ— repeating unit and represented by Formula 1b:
—[—(R₁SiO_{1.5})ₐ—(R₁₁SiO_{1.5})_{b}—]ₙ— (1b)
wherein R₁ is independently selected from the group consisting of a hydrogen atom, a hydroxy group, a C1-C15 alkyl group, a C1-C15 alkoxy group, a C6-C20 aryl group, a C7-C25 alkylaryl group and a C7-C25 arylalkyl group;
R₁₁ represents an organometallic complex-containing group having a metal selected from the group consisting of Ir, Os, Pt, Pb, Re, Ru and Pd;
n is an integer not less than 2; and
a mixing molar ratio of a and b is 1:99 to 99:1.

17. The organic electroluminescent device of claim 15, the organometallic complex containing group is represented by one of Formulae 2 and 3: 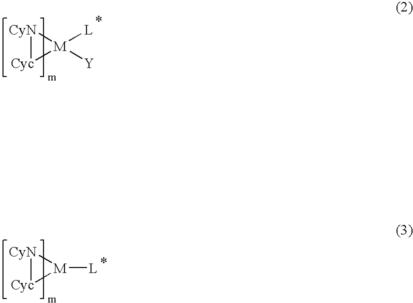
wherein M is selected from the group consisting of Ir, Os, Pt, Pb, Re, Ru and Pd;
CyN is a substituted or unsubstituted C3-C60 heterocyclic group containing nitrogen bonded to M, or a substituted or unsubstituted C3-C60 heteroaryl group containing nitrogen bonded to M;
CyC is selected from the group consisting of a substituted or unsubstituted 4 to 60 carbocyclic group containing carbon bonded to M, substituted or unsubstituted C3-C60 heterocyclic group containing carbon bonded to M, a substituted or unsubstituted C3-C60 aryl group containing carbon bonded to M and a substituted or unsubstituted C3-C60 heteroaryl group containing carbon bonded to M;
CyN-CyC represents a cyclometalating ligand bonded to M through nitrogen (N) and carbon (C);
L is a monodentate ligand or a bidentate ligand;
Y is a monoanionic ligand or a monodentate ligand;
m is 1 or 2; and
the asterisk mark, *, represents a bonding position for Si.

18. The organic electroluminescent device of claim 16, the organometallic complex containing group is represented by one of Formulae 2 and 3: 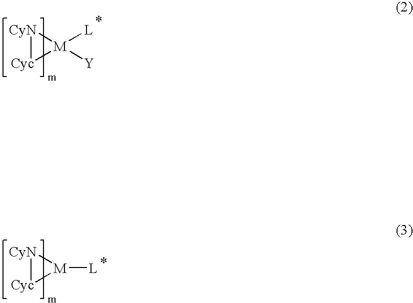
wherein M is selected from the group consisting of Ir, Os, Pt, Pb, Re, Ru and Pd;
CyN is a substituted or unsubstituted C3-C60 heterocyclic group containing nitrogen bonded to M, or a substituted or unsubstituted C3-C60 heteroaryl group containing nitrogen bonded to M;
CyC is selected from the group consisting of a substituted or unsubstituted 4 to 60 carbocyclic group containing carbon bonded to M, substituted or unsubstituted C3-C60 heterocyclic group containing carbon bonded to M, a substituted or unsubstituted C3-C60 aryl group containing carbon bonded to M and a substituted or unsubstituted C3-C60 heteroaryl group containing carbon bonded to M;
CyN-CyC represents a cyclometalating ligand bonded to M through nitrogen (N) and carbon (C);
L is a monodentate ligand or a bidentate ligand;
Y is a monoanionic ligand or a monodentate ligand;
m is 1 or 2; and
the asterisk mark, *, represents a bonding position for Si.

19. The organic electroluminescent device of claim 17, wherein the CyN-CyC is represented by one of the following formulas (a) through (p): 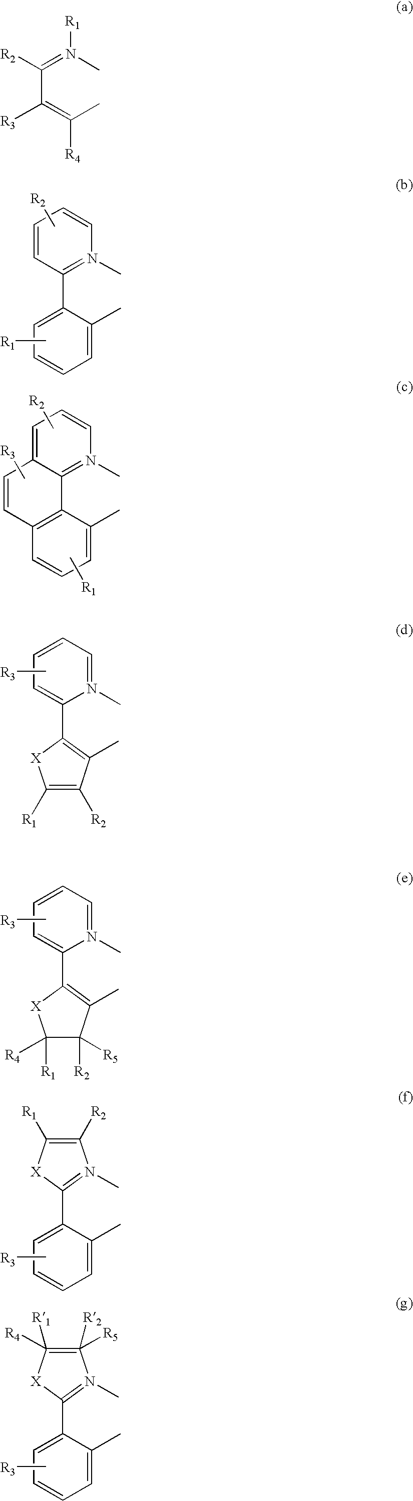 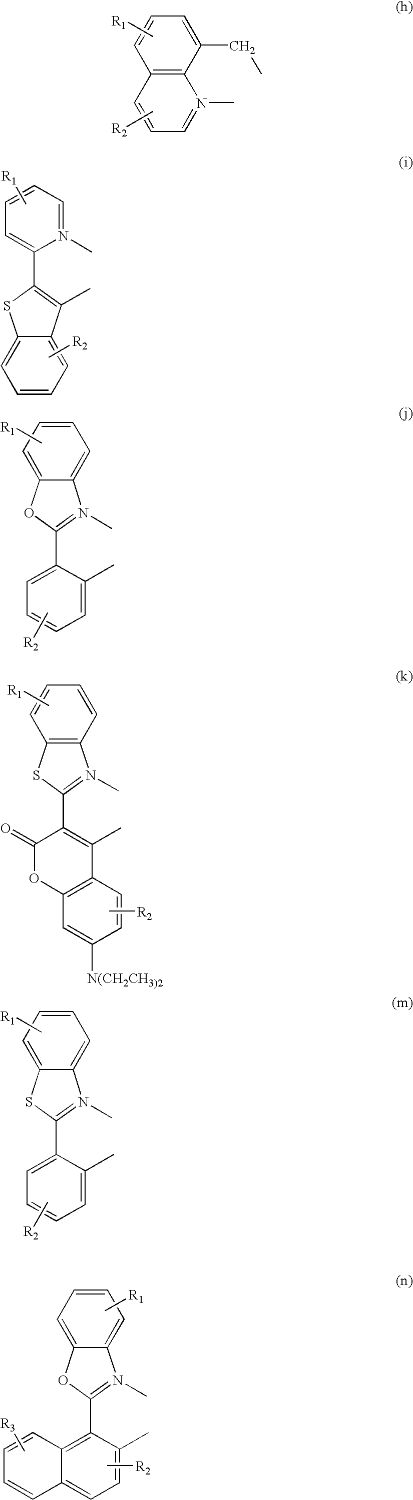 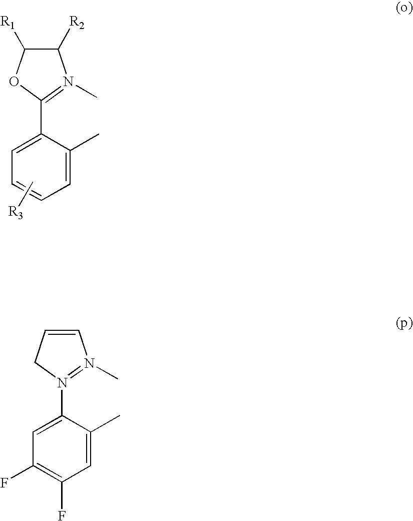
wherein L is one of a ligand represented by one of the following formulas (q) through (z), and (a′) through (p′) and a substituted or unsubstituted derivative of one selected from the group consisting of triethylamine, propylamine, cyclohexylamine, pyrrolidine, pyrroline, piperidine, pyrimidine, indole, azaindole, carbazole, indazole, norharman, harman, aniline, imidazole, oxazole, thiazole, pyrazole, pyrrole, benzimidazole, benzotriazole, benzoxazole, benzothiazole, benzoselenazole, benzothiadiazole, isoxazole, isothiazole, oxadiazole, thiadiazole, anthranyl, triazine, benzisoxazole, pyrazine, quinoline, benzoquinoline, acridine, thiazoline, quinuclidine, imidazoline, oxazoline, thiazoline, and isoquinoline;
Y is —F, —Cl, —Br, —I, —CN, —CN(R′″), —SCN or —OCN, where R′″ is a substituted or unsubstituted C1-C20 alkyl group: 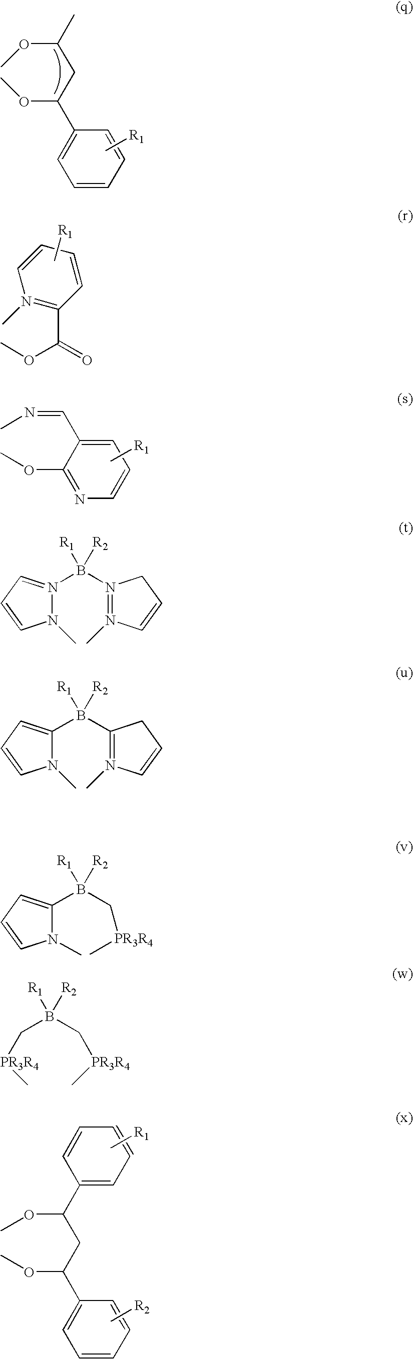 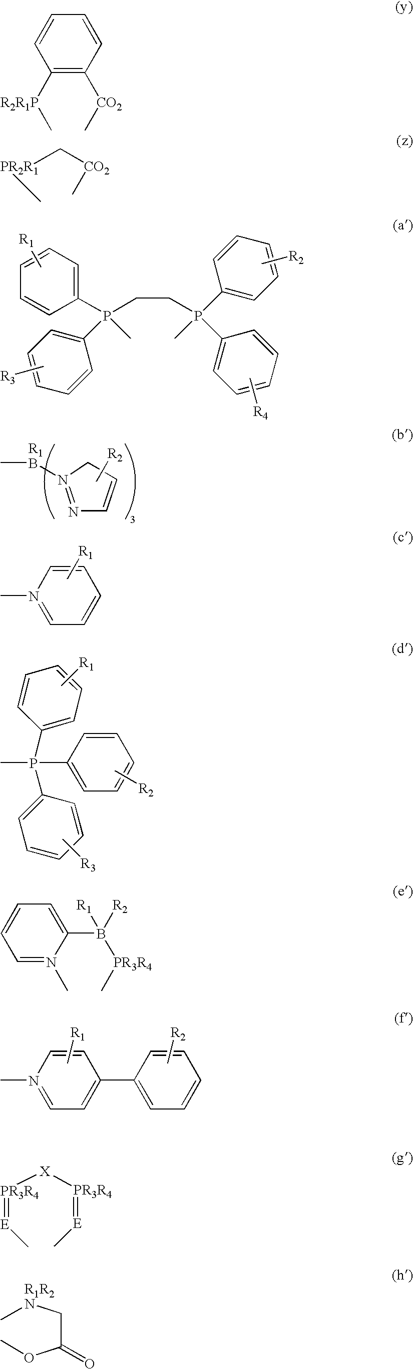 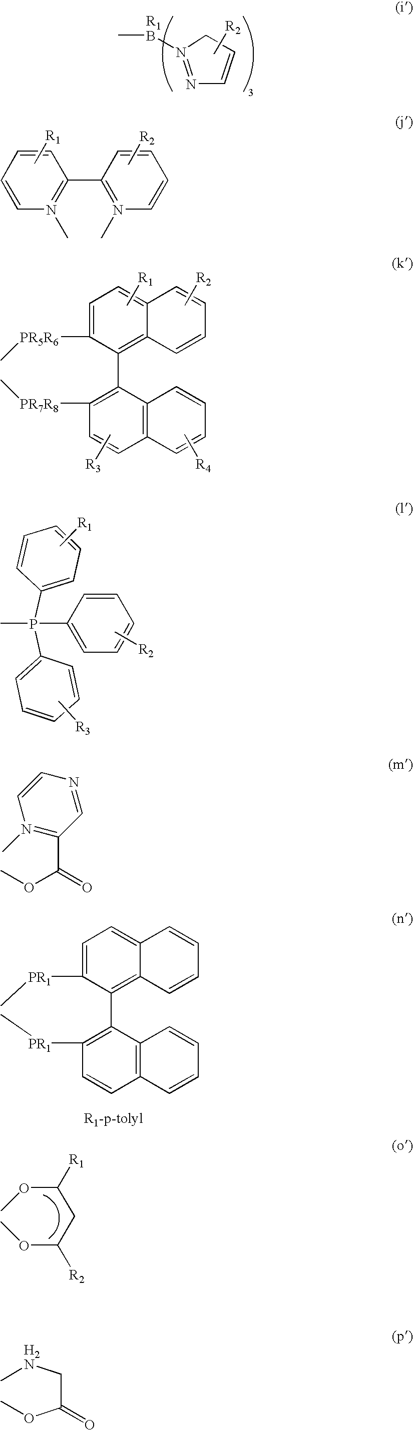
wherein R₁, R₂, R₃, R₄, R₅, R₆, R₇ and R₈ are each independently a monosubstituted or multisubstituted substituent, and are each selected from the group consisting of hydrogen, a halogen atom, —OR′, —N(R′)₂, —P(R′)₂, —POR′, —PO₂R′, —PO₃R′, —SR′, —Si(R′)₃, —B(R′)₂, —B(OR′)₂, —C(O)R′, —C(O)OR′, —C(O)N(R′), —CN, —NO₂, —SO₂, —SOR, —SO₂R′, —SO₃R′, C1-C20 alkyl, and C6-C20 aryl, where R′ is selected from the group consisting of a hydrogen atom, a substituted or unsubstituted C1-C20 alkyl, substituted or unsubstituted C1-C10 alkoxy, substituted or unsubstituted C2-C20 alkenyl, substituted or unsubstituted C2-C20 alkynyl, substituted or unsubstituted C1-C20 heteroalkyl, substituted or unsubstituted C6-C40 aryl, substituted or unsubstituted C7-C40 arylalkyl, substituted or unsubstituted C7-C40 alkylaryl, substituted or unsubstituted C2-C40 heteroaryl, and substituted or unsubstituted C3-C40 heteroarylalkyl;
X is CH, S, O or NR″, where R″ is a hydrogen atom or a C1-C20 alkyl group; and
E is O, S, Se or Te.

20. The organic electroluminescent device of claim 18, wherein the CyN-CyC is represented by one of the following formulas (a) through (p): 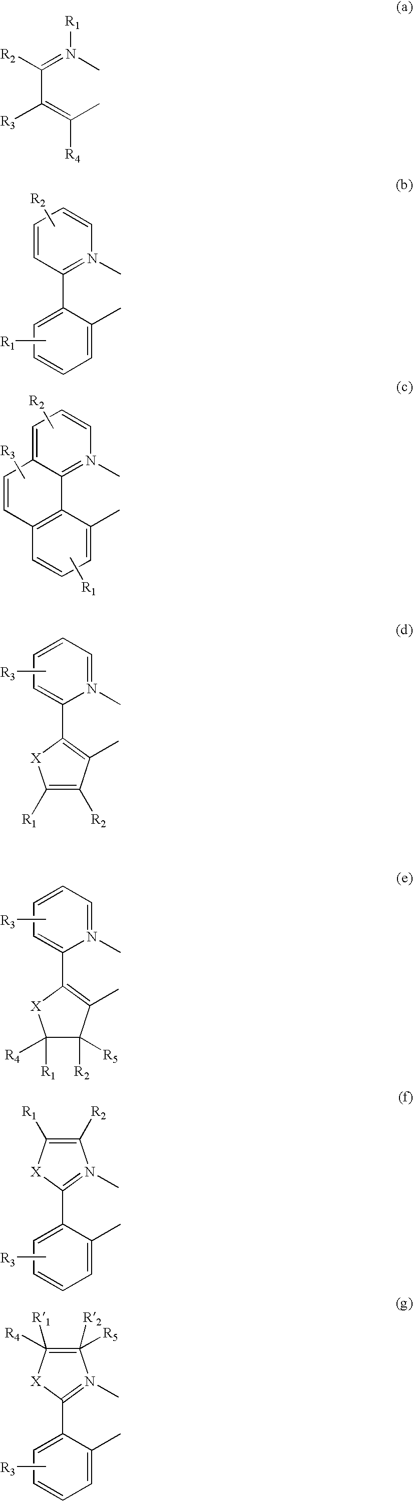 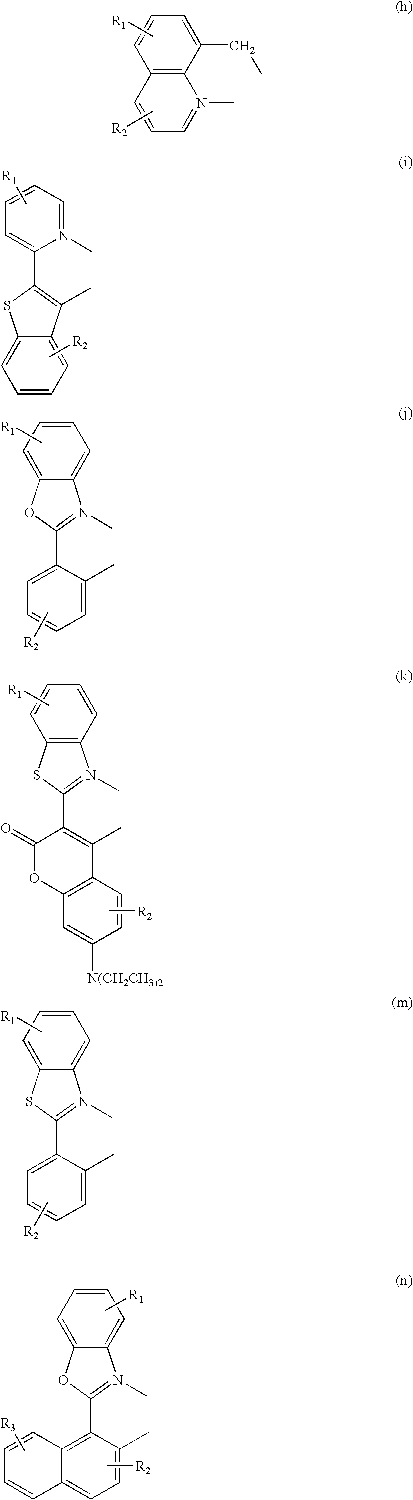
wherein L is one of a ligand represented by one of the following formulas (q) through (z), and (a′) through (p′) and a substituted or unsubstituted derivative of one selected from the group consisting of triethylamine, propylamine, cyclohexylamine, pyrrolidine, pyrroline, piperidine, pyrimidine, indole, azaindole, carbazole, indazole, norharman, harman, aniline, imidazole, oxazole, thiazole, pyrazole, pyrrole, benzimidazole, benzotriazole, benzoxazole, benzothiazole, benzoselenazole, benzothiadiazole, isoxazole, isothiazole, oxadiazole, thiadiazole, anthranyl, triazine, benzisoxazole, pyrazine, quinoline, benzoquinoline, acridine, thiazoline, quinuclidine, imidazoline, oxazoline, thiazoline, and isoquinoline;
Y is —F, —Cl, —Br, —I, —CN, —CN(R′″), —SCN or —OCN, where R′″ is a substituted or unsubstituted C1-C20 alkyl group: 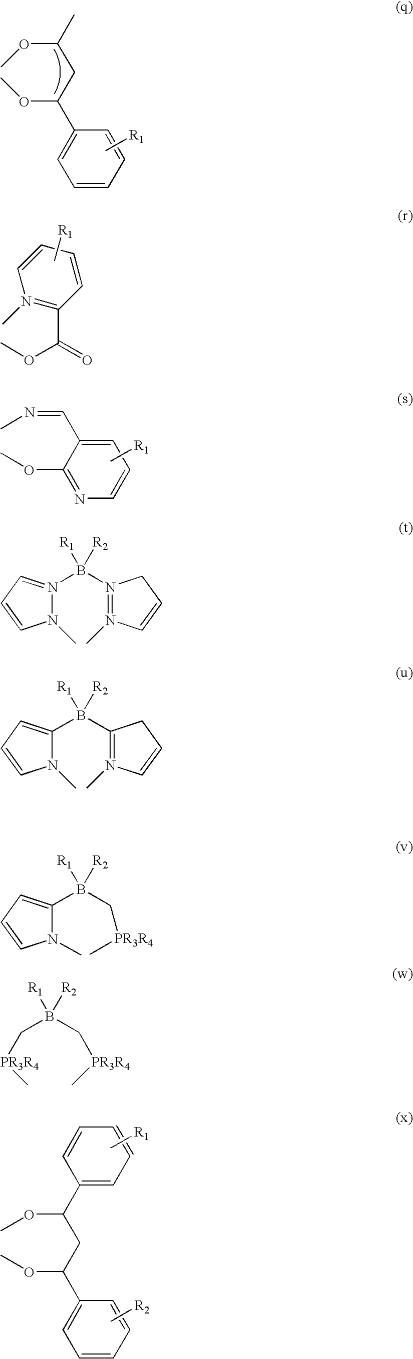 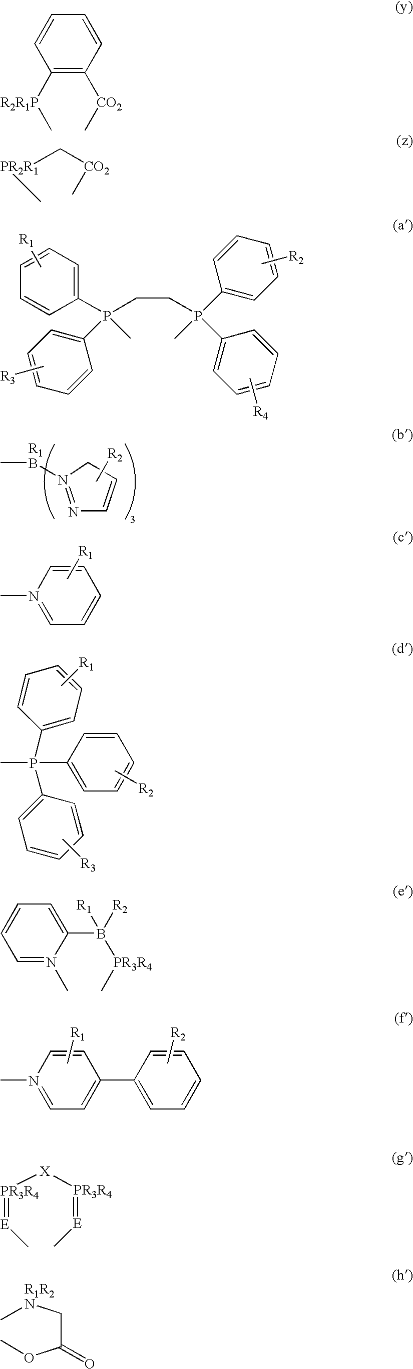 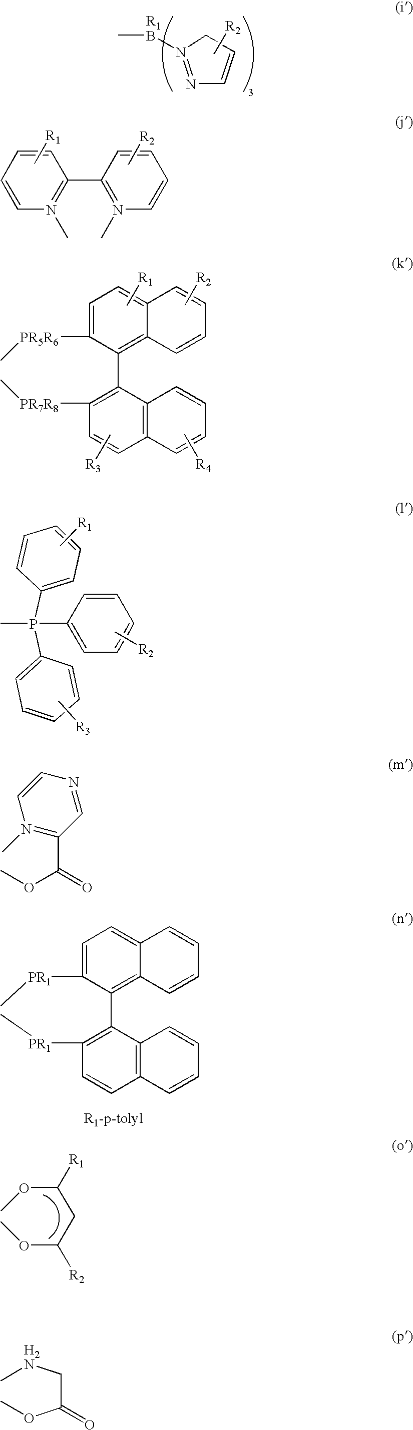
wherein R₁, R₂, R₃, R₄, R₅, R₆, R₇ and R₈ are each independently a monosubstituted or multisubstituted substituent, and are each selected from the group consisting of hydrogen, a halogen atom, —OR′, —N(R′)₂, —P(R′)₂, —POR′, —PO₂R′, —PO₃R′, —SR′, —Si(R′)₃, —B(R′)₂, —B(OR′)₂, —C(O)R′, —C(O)OR′, —C(O)N(R′), —CN, —NO₂, —SO₂, —SOR, —SO₂R′, —SO₃R′, C1-C20 alkyl, and C6-C20 aryl, where R′ is selected from the group consisting of a hydrogen atom, a substituted or unsubstituted C1-C20 alkyl, substituted or unsubstituted C1-C10 alkoxy, substituted or unsubstituted C2-C20 alkenyl, substituted or unsubstituted C2-C20 alkynyl, substituted or unsubstituted C1-C20 heteroalkyl, substituted or unsubstituted C6-C40 aryl, substituted or unsubstituted C7-C40 arylalkyl, substituted or unsubstituted C7-C40 alkylaryl, substituted or unsubstituted C2-C40 heteroaryl, and substituted or unsubstituted C3-C40 heteroarylalkyl;
X is CH, S, O or NR″, where R″ is a hydrogen atom or a C1-C20 alkyl group; and
E is O, S, Se or Te.

21. The organic electroluminescent device of claim 15, wherein the organic layer is an electroluminescent layer.
